(19) United States
(12) Patent Application Publication
(10) Pub. No.: US 2017/0031056 A1
(43) Pub. Date: Feb. 2, 2017

(54) Solar Energy Forecasting

(71) Applicants: Rolando Vega-Avila, San Antonio, TX (US); Hariharan Krish-Naswami, Helotes, TX (US); Jaro Nummikoski, Helotes, TX (US)

(72) Inventors: Rolando Vega-Avila, San Antonio, TX (US); Hariharan Krish-Naswami, Helotes, TX (US); Jaro Nummikoski, Helotes, TX (US)

(73) Assignee: Board of Regents, The University of Texas System, Austin, TX (US)

(21) Appl. No.: 15/303,164

(22) PCT Filed: Apr. 10, 2015
(86) PCT No.: PCT/US15/25320

§ 371 Date: Oct. 10, 2016

Related U.S. Application Data
(60) Provisional application No. 61/977,834, filed on Apr. 10, 2014.

(51) Int. Cl. G01W 1/12; G06Q 10/06; G06N 3/08; G01W 1/10; G06N 3/04

(52) U.S. Cl. CPC G01W 1/12; G01W 1/10; G06N 3/04; G06N 3/08; G06Q 10/0635

(57) ABSTRACT

Aspects of solar energy forecasting are described herein. In one embodiment, a method of solar energy forecasting includes masking at least one sky image to provide at least one masked sky image, where the at least one sky image includes an image of at least one cloud captured by a sky imaging device. The method further includes geometrically transforming the at least one masked sky image to at least one flat sky image based on a cloud base height of the at least one cloud. Once the cloud is identified, the motion of the at least one cloud may be determined over time. Rays of solar irradiance can be traced using the identified clouds and cloud motion and a solar energy forecast generated by ray tracing the irradiance of the sun upon a geographic location according to the motion of the at least one cloud.

### CROSS-REFERENCE TO RELATED APPLICATIONS

This application claims the benefit of U.S. Provisional Application No. 61/977,834, filed Apr. 10, 2014, the entire contents of which are hereby incorporated herein by reference.

### BACKGROUND

Increased solar photovoltaic efficiency and decreased manufacturing costs have driven growth in solar electricity generation. To some extent, however, adding solar generation poses a problem due to the variability and intermittency of solar irradiance. In that context, solar forecasts may be relied upon to provide utility companies with a prediction of power output from large-scale or distributed solar installations, for example. Such predictions decrease the risk associated with bidding renewable electricity to the regional grid.

### BRIEF DESCRIPTION OF THE DRAWINGS

Many aspects of the present disclosure can be better understood with reference to the following drawings. The drawings are not necessarily to scale, with emphasis instead being placed upon clearly illustrating the principles of the disclosure. Moreover, in the drawings, like reference numerals designate corresponding, but not necessarily the same, parts throughout the several views.

FIG. 1 illustrates a solar energy forecasting system according to various embodiments of the present disclosure.

FIG. 2 illustrates an example solar energy forecasting process performed by the energy forecasting system in FIG. 1 according to various embodiments of the present disclosure.

FIG. 3 illustrates an example sky imager calibration process according to various embodiments of the present disclosure.

FIGS. 4A and 4B illustrate an obstructed sky image and a masked sky image, respectively, according to various embodiments of the present disclosure.

FIG. 5 illustrates an obstructed sky image according to various embodiments of the present disclosure.

FIG. 6 illustrates an example area of influence according to various embodiments of the present disclosure.

FIG. 7 illustrates an example of azimuth angle correction according to various embodiments of the present disclosure.

FIG. 8 illustrates an example azimuth angle adjustment process according to various embodiments of the present disclosure.

FIG. 9 illustrates an example interpolated region according to various embodiments of the present disclosure.

FIG. 10 illustrates example camera arm and shadow band location grid areas according to various embodiments of the present disclosure.

FIGS. 11A and 11B illustrate the geometric transformation of a masked sky image to a sky coordinates image according to various embodiments of the present disclosure.

FIG. 12 illustrates example pixel coordinate values of a sky image according to various embodiments of the present disclosure.

FIG. 13 illustrates an example azimuth angle of a sky image according to various embodiments of the present disclosure.

FIG. 14 illustrates an example camera view angle from inside a camera according to various embodiments of the present disclosure.

FIG. 15 illustrates an example sky view angle for a hemispherical dome according to various embodiments of the present disclosure.

FIG. 16 illustrates parameters for an image transformation procedure according to various embodiments of the present disclosure.

FIG. 17 illustrates a coordinate transform according to various embodiments of the present disclosure.

FIG. 18 illustrates a pixel to zenith correlation of an original sky image according to various embodiments of the present disclosure.

FIG. 19 illustrates a transformed pixel to zenith correlation in a resulting sky image transformation procedure according to various embodiments of the present disclosure.

FIG. 20 illustrates the effect that the transformation procedure has on clouds according to various embodiments of the present disclosure.

FIG. 21 illustrates a binary image representing only clouds in a sky image according to various embodiments of the present disclosure.

FIG. 22 illustrates original, red, and blue intensity images for a clouded and clear sky according to various embodiments of the present disclosure.

FIG. 23 illustrates a histogram of red/blue ratio intensities for an original sky image compared to a clear sky image according to various embodiments of the present disclosure.

FIG. 24 illustrates a histogram of red/blue ratio intensities minus such intensities for a clear sky image according to various embodiments of the present disclosure.

FIG. 25 illustrates a resulting image from the subtraction of the clear sky red/blue ratio from the original image red/blue ratio according to various embodiments of the present disclosure.

FIG. 26 illustrates a histogram of cloud boundaries according to various embodiments of the present disclosure.

FIG. 27 illustrates original and cloud density segmented images according to various embodiments of the present disclosure.

FIG. 28 illustrates a process of identifying cloud motion according to various embodiments of the present disclosure.

FIG. 29 illustrates a process of identifying characteristics of cloud motion according to various embodiments of the present disclosure.

FIG. 30 illustrates binary segmented cloud images over time according to various embodiments of the present disclosure.

FIG. 31 illustrates histograms resulting from cloud movement matrices according to various embodiments of the present disclosure.

FIG. 32 illustrates histograms resulting from closest centroid distance for both movement speed and direction according to various embodiments of the present disclosure.

FIG. 33 illustrates histograms resulting from the use of motion assumptions according to various embodiments of the present disclosure.

FIG. 34 illustrates a cloud motion search path graphic according to various embodiments of the present disclosure.

FIG. 35 illustrates an example of clouds detected in a search path according to various embodiments of the present disclosure.

FIG. 36 illustrates the results of the cloud matching process according to various embodiments of the present disclosure.

FIG. 37 illustrates an original cloud region and its binary region representation according to various embodiments of the present disclosure.

FIG. 38 illustrates a complete process of creating a future image according to various embodiments of the present disclosure.

FIG. 39 illustrates final sky image results of creating future images according to various embodiments of the present disclosure.

FIG. 40 illustrates a binary segmented cloud image and an aerial view of a geographic region according to various embodiments of the present disclosure.

FIG. 41 illustrates a view of the geometry for calculating a projection of cloud shadows onto the ground according to various embodiments of the present disclosure.

FIG. 42 illustrates a ray tracing procedure performed from a ground pixel location through a cloud image layer to the sun according to various embodiments of the present disclosure.

FIGS. 43 and 44 illustrate ground pixels referenced to locations of a sky imager according to various embodiments of the present disclosure.

FIG. 45 illustrates a cross-hair approach used to determine the value for irradiance estimation according to various embodiments of the present disclosure.

FIG. 46 illustrates an example giving more weight to pixels closer to a reference pixel according to various embodiments of the present disclosure.

FIG. 47 illustrates a diagram of the use of a Monte Carlo simulation according to various embodiments of the present disclosure.

FIG. 48 illustrates an example of a user interface according to various embodiments of the present disclosure.

FIG. 49 illustrates an example of another user interface according to various embodiments of the present disclosure.

FIG. 50 illustrates an example schematic block diagram of the computing environment employed in the networked environment of FIG. 1 according to various embodiments of the present disclosure.

### DETAILED DESCRIPTION

As noted above, solar forecasts may be relied upon to provide utility companies with a prediction for power output from large-scale or distributed solar installations. Such predictions decrease the risk associated with bidding renewable electricity to the regional power grid. The current state of the art in solar forecasting is focused on hour-ahead and day-ahead time horizons using publicly available satellite imagery or numerical weather prediction models. Conventional intra-hour solar forecasting approaches capture the timing of irradiance peaks and troughs using an “on/off” signal multiplied with an irradiance reference curve. These conventional methods do not representatively capture the severity of drops or spikes in solar energy. Also, in the conventional approaches, only one prediction value of irradiance is provided, without mention of any associated uncertainty.

For utility companies, reliance on solar forecasts has grown as the number and size of solar farms has increased over time. Utility companies have been primarily concerned with day-ahead forecasting due to the financial impact in bidding solar energy to regional independent system operators (ISOs). Power output in day-ahead forecasting approaches, however, tends to be over-predicted on cloudy days and under-predicted on sunny days. In most geographic locations, both errors are likely to happen frequently. As such, it is important to have a quantification of the uncertainty related to each day-ahead forecast.

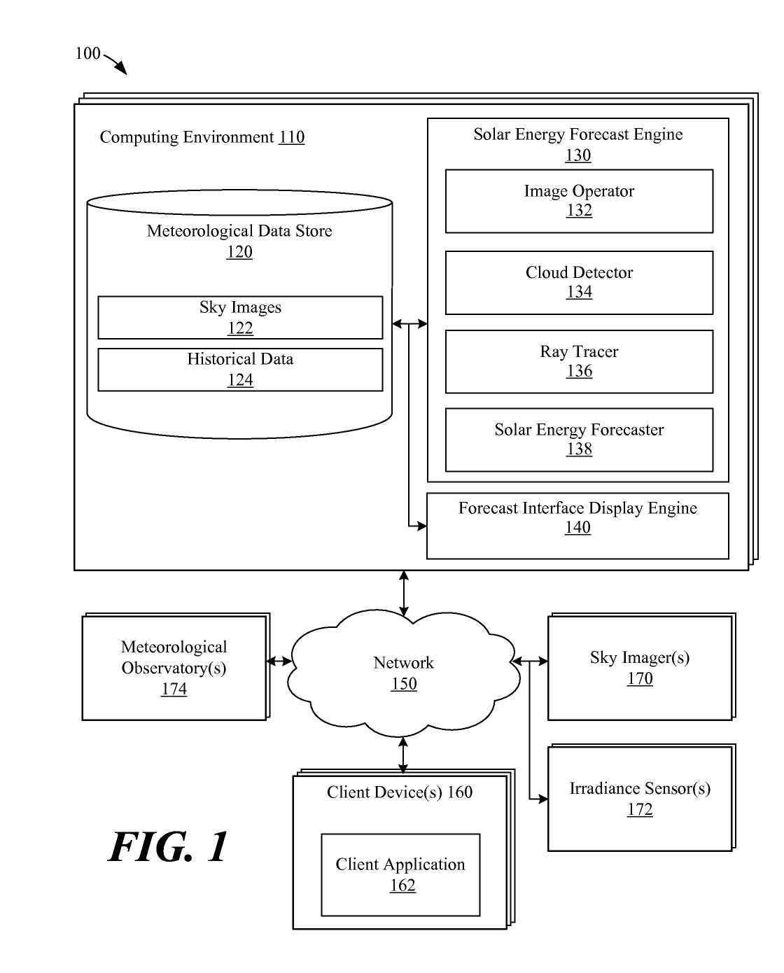

Turning to FIG. 1, a more detailed description of the embodiments is provided. FIG. 1 illustrates a solar energy forecasting system 100 according to various embodiments of the present disclosure. In the following paragraphs, a general description of the system 100 is provided, followed by a discussion of the operation of the same. Among other system elements, the system 100 includes a computing environment 110, a network 150, a client device 160, a sky imager 170, an irradiance sensor 172, and a meteorological observatory 174.

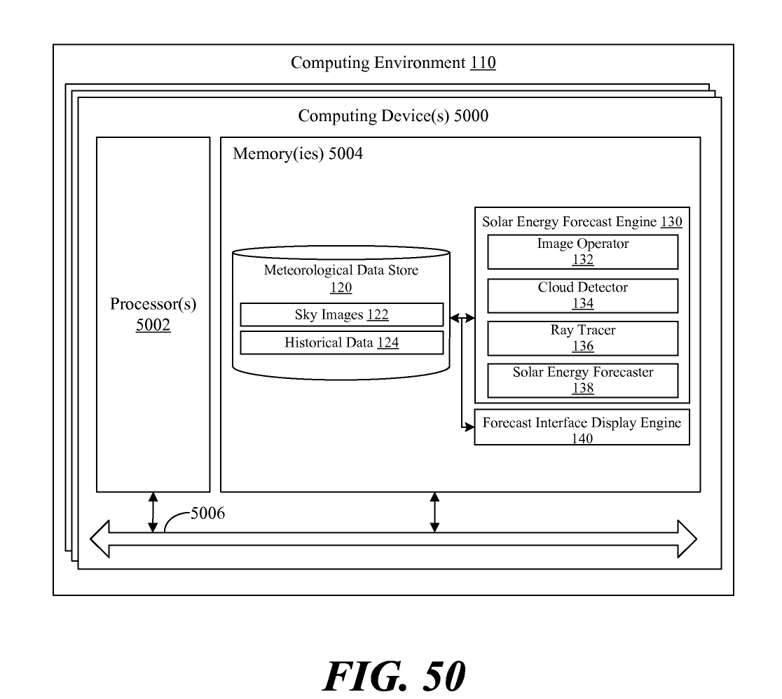

The computing environment 110 may be embodied as a computer, computing device, or computing system. In certain embodiments, the computing environment 110 may include one or more computing devices arranged, for example, in one or more server or computer banks. The computing device or devices may be located at a single installation site or distributed among different geographical locations. As further described below in connection with FIG. 50, the computing environment 110 may include a plurality of computing devices that together embody a computing resource. In some cases, the computing environment 110 may be embodied as an elastic computing resource where an allotted capacity of processing, network, storage, or other computing-related resources varies over time.

The computing environment 110 is also embodied, in part, as various functional and/or logic (e.g., computer-readable instruction, device, circuit, processing circuit, etc.) elements executed or operated to direct the computing environment 110 to perform aspects of the embodiments described herein. As illustrated in FIG. 1, the computing environment 110 includes a meteorological data store 120, a solar energy forecast engine 130, and a forecast interface display engine 140. The meteorological data store 120 includes sky images 122 and historical data 124, each of which is described in further detail below. The solar energy forecast engine 130 includes an image operator 132, a cloud detector 134, a ray tracer 138, and a solar energy forecaster 138, each of which is described in further detail below.

The network 150 may include the Internet, intranets, extranets, wide area networks (WANs), local area networks (LANs), wired networks, wireless networks, cable networks, satellite networks, other suitable networks, or any combinations thereof. It is noted that the computing environment 110 may communicate with the client device 160, the sky imager 170, the irradiance sensor 172, and the meteorological observatory 174 using any suitable protocols for communicating data over the network 150, without limitation.

The client device 160 is representative of one or more client devices. The client device 160 may be embodied as any computing device, processing circuit, or processor based device or system, including those embodied in the form of a desktop computer, a laptop computer, a personal digital assistant, a cellular telephone, or a tablet computer, among other example computing devices and systems. The client device 160 may include one or more peripheral devices, such as one or more input devices, keyboards, keypads, touch pads, touch screens, microphones, scanners, pointer devices, cameras, etc.

The client device 160 may execute various applications, such as the client application 162. In one embodiment, the client application 162 may be embodied as a data analysis and/or energy forecasting application for interaction with the computing environment 110 via the network 150. In that context, the forecast interface display engine 140 may generate a user interface in the client application 162 on the client device 160, as described in further detail below.

The sky imager 170 is representative of one or more imaging tools or devices capable of capturing an image of the sky. Among other suitable imaging tools, the sky imager 170 may be embodied as a Total Sky Imager model 880 (TSI-880) or Total Sky Imager model 440 (TSI-440) manufactured by Yankee Environmental Systems, Inc. of Turners Falls, Mass. In one embodiment, the sky imager 170 includes a solid-state CCD or other suitable image sensor and associated optics directed to capture images of the sky reflected off of a heated, rotating hemi- or semi-spherical mirror. A shadow band on the mirror may be relied upon to block one or more regions or bands of intense, direct-normal light from the sun, protecting the image sensor and associated optics of the sky imager 170. The image sensor in the sky imager 170 can capture images at any suitable resolution, such as at 288×352, 640×480, 1024×768, or other (e.g., higher or lower) resolutions.

Among other suitable irradiance sensors, the irradiance sensor 172 may be embodied as a LI-COR® 210SA photometric sensor manufactured by LI-COR, Inc. of Lincoln, Nebr. The sensor in the irradiance sensor 172 may consist of a filtered silicon photodiode placed within a fully cosine-corrected sensor head that provides a response to radiation at various angles of incidence. This sensor measures global horizontal irradiance in watts per meter squared (W/m²). The irradiance sensor 172 may be used to gather data, for example, or to test the accuracy of the solar forecasting engine 130.

The meteorological observatory 174 is representative of one or more locations where meteorological data is gathered and/or stored, such as the Renewable Energy Laboratory (NREL) website, Automated Surface Observing System (ASOS) locations, Automated Weather Observing System (AWOS) locations, and Automated Weather Sensor System (AWSS) locations. At the meteorological observatory 174 locations, various types of instruments may be relied upon to gather meteorological data. Among others, the instruments may include mechanical wind vane or cup systems or ultrasonic pulse sensors to measure wind speed, scatter sensors or transmissometers to measure visibility, light emitting diode weather identifier (LEDWI) sensors to measure precipitation, ceilometers which use pulses of infrared radiation to determine the height of the cloud base, temperature/dew point sensors, barometric pressure sensors, and lighting detectors, for example.

Turning back to aspects of the computing environment 110, over time, the solar energy forecast engine 130 may receive and store sky images captured by the sky imager 170, irradiance data determined by the irradiance sensor 172, and meteorological data measured by the meteorological observatory 174. This data may be stored in the meteorological data store 120.

In the meteorological data store 120, the sky images 122 include images captured by the sky imager 170 over time. The sky images may be captured by the sky imager 170 at any suitable interval during daylight hours. At a ten-minute interval, for example, the sky imager 170 may capture about 60 sky images on an average day, and these images may be stored as the sky images 122. The sky images 122 may also include a database of clear sky images (i.e., cloud-free sky images) associated with certain zenith and azimuth attributes. To create a sub-dataset of clear sky images, sky images having zero clouds are first identified. The clear sky images are then separated into bins according to zenith angle for ease of reference.

The historical data 124 includes various types of meteorological data, such as irradiance (e.g., global horizontal irradiance (GHI), diffuse horizontal irradiance (DHI), and/or direct normal irradiance (DNI)), solar zenith angle, solar azimuth angle, solar positioning and intensity (SOLPOS)), temperature, relative humidity, cloud cover percentage, cloud height (e.g., ceilometer), wind speed, wind direction, dew point, precipitation, visibility, barometric pressure, lightning, meteorological aerodrome report (METAR), and other data, gathered from various sources and dating back over time. The meteorological data may be acquired, in part, from the NREL website, the ASOS database, or other public or private entities. For example, the NREL website may be referenced for sky images and the ASOS database may be referenced for ceilometer cloud base height and other meteorological data. The ceilometer readings may be obtained from the ASOS database at one or more airports, for example.

It should be appreciated that, because the databases, such as the NREL and ASOS databases, store data gathered from various instruments at various times, the meteorological data may be indexed, organized, and stored in the meteorological data store 120 in suitable manner for reference by the solar energy forecast engine 130. In other words, the meteorological data may be indexed, cross-correlated, and/or organized by time and/or instrument, for example, to match readings over time. Among embodiments, the historical data 124 may be organized into one or more time-interval databases including meteorological data entries at certain periodic or aperiodic time intervals, such as thirty seconds, one minute, five minutes, ten minutes, one hour, or other time intervals or combinations thereof. In a one-minute interval format database, for example, data may be provided at one-minute intervals for the entire length of one or more days. For instruments that do not record readings at such a small interval, linear interpolation may be used to populate data values. As another example, where an instrument, such as the sky imager 170, captures data at an interval of time that is longer than the periodic time interval of a certain time-interval database, default, dummy, null, or not-a-number entries may be populated in the database. Alternatively, data may be interpolated or copied across open entries.

The historical data 124 can be updated in real time by the solar energy forecast engine 130 and additional information can be added as desired. This open-ended nature of the historical data 124 allows data from additional instruments to be added as needed. When analyzing and processing the historical data 124, users may identify new variables or data types to include. Such new information can be processed and added into to the historical data 124 at any time by the solar energy forecast engine 130. During both short-term and long-term forecasting processes, new variables and data such as cloud cover, cloud segmentation gradients, and various weather related derivatives are typically generated and added to the historical data 124 in a continuous feedback loop by the solar energy forecast engine 130.

The historical data 124 may be referenced by the solar energy forecast engine 130 to quantify probabilities and patterns in solar energy forecasts that can, in turn, inform real-time decisions and day-ahead models. In that context, the historical data 124 may support the development of accurate solar energy forecasts and also act as a historical database for operators to draw conclusions. One objective of the organization and maintenance of the historical data 124 is to enable enhanced scientific quantifications of confidence levels in solar power generation that may be expected from intra-hour and day-ahead models.

Turning to other aspects of the computing environment 110, the image operator 32 is configured to manipulate the sky images so that they can be effectively interpreted by the cloud detector 136 and/or the ray tracer 138, as further described below, to provide a solar energy forecast. One such form of manipulation is obstruction masking, in which undesirable objects are removed from the sky images and replaced with estimated representations of the blocked area of sky. It is noted that the cloud detection performed by the cloud detector 136, for example, as well as other processes performed by the solar energy forecast engine 130, may benefit from the removal of obstructions, noise, and other artifacts present in sky images captured by the sky imager 170. In that context, the image operator 132 may mask obstructions in sky image for future processes.

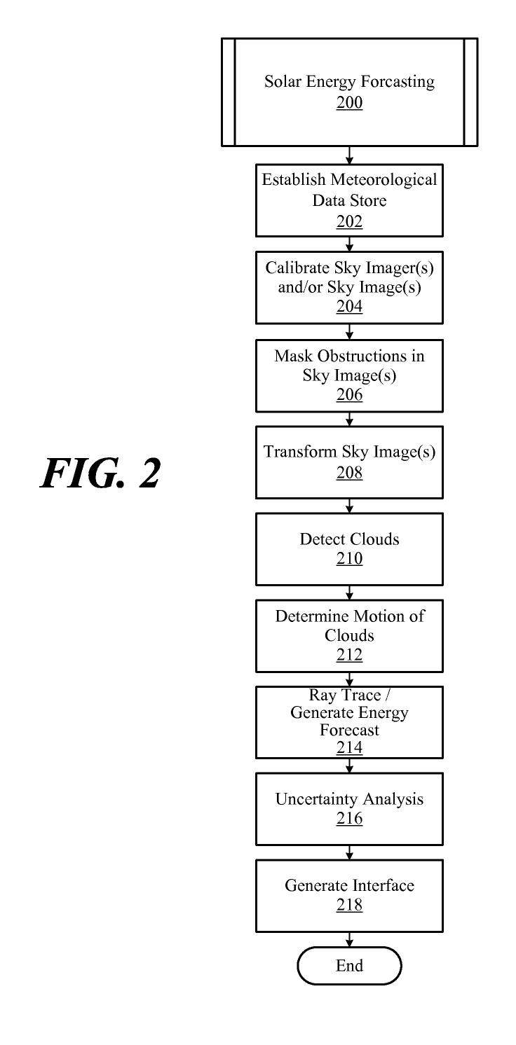

The cloud detector 134 is configured to detect and identify individual clouds in sky images. The cloud detector 134 is further configured to determine the movement of clouds in sky images over time. The ray tracer 136 is configured to trace the irradiance of the sun upon one or more geographic locations based on the motion of clouds in sky images over time. Finally, the solar energy forecaster 138 is configured to generating a solar energy forecast based on the trace of irradiance of the sun upon the one or more geographic locations. In one embodiment, the solar energy forecast may be provided as an intra-hour forecast, although other types of forecasts are within the scope of the embodiments. Further aspects of the operation of the energy forecast engine 130 are described below with reference to FIG. 2.

FIG. 2 illustrates an example solar energy forecasting process 200 performed by the energy forecasting system 100 in FIG. 1 according to an embodiment of the present disclosure. It should be appreciated that that the flowchart of FIG. 2 provides merely one example of a functional sequence or arrangement that may be employed to implement the operations of the energy forecasting system 100 described herein. It is also noted that, although the process 200 is described in connection with elements of the computing environment 110 in FIG. 1, other computing environments may perform the process 200 illustrated in FIG. 2. In certain aspects, the flowchart of FIG. 2 may be viewed as depicting an example group of steps performed by the computing environment 110 according to one or more embodiments.

At reference numeral 202, the process 200 includes establishing a meteorological data store. For example, the solar energy forecast engine 130, with or without user direction, may retrieve, receive, and/or store sky images captured by the sky imager 170, irradiance data determined by the irradiance sensor 172, and meteorological data measured by the meteorological observatory 174 (FIG. 1). This data may be gathered and organized in the meteorological data store 120 at reference numeral 202. The data may be organized in any suitable fashion described herein for reference and analysis by the solar energy forecast engine 130. In a variation on the process 200, if the meteorological data store 120 was previously provided or prepared, reference numeral 202 may be omitted.

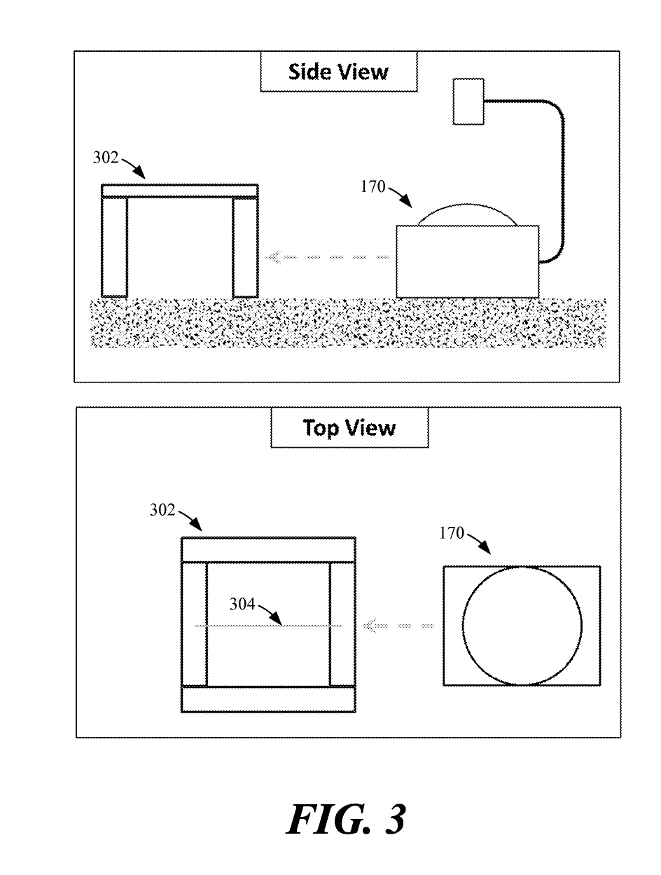

At reference numeral 204, the process 200 includes calibrating one or more of the sky imager 170 and/or images captured by the sky imager 170. It is noted here that, for accuracy in forecasting, image processing should be performed with orientation-aligned sky images from the sky imager 170. In one embodiment, the images captured from the sky imager 170 are substantially aligned with true north with the assistance of an external device 302, as shown in FIG. 3. The external device 302 is oriented such that the wire 304 is substantially aligned to true north. The sky imager 170 is then positioned under the external device 302. Once positioned, the sky imager 170 may be adjusted until the images generated by the sky imager 170 are (at least substantially) aligned to true north.

The calibration procedure may also be conducted using an image orientation tuning tool of the sky imager 170. The tool may permit various adjustments and overlays for a captured sky image. The image center pixel and dome radius may be determined using the tool. The tool may also allow for the overlay of an azimuth angle and side bands that are used to test the alignment of the shadow band with the expected azimuth angle determined by the solar calculator. The tool displays the north alignment overlay, which is used in the procedure to align the image with true north.

The imager enclosure or camera arm cannot generally be used to accurately align the sky imager 170 to true north. For this reason, the following procedure may be relied upon achieve true north alignment. First, the wire 304 is aligned to true north. The external device 302 may be constructed out of wood so no error is introduced by the use of metal. Second, the sky imager 170 is slid under the external device 302. With the sky imager 170 in position under the external device 302, a reference sky image is taken, run through the orientation tool, and tested against the north alignment overlay of the tool. The sky imager 170 may be moved in the appropriate direction until the reference sky image has been aligned with the true north reference. Finally, the shadow band is aligned with the true north starting position. Once the shadow band is in the proper position in the image, the north orientation may be set in the orientation tuning tool of the sky imager 170 to control the rotation of the shadow band.

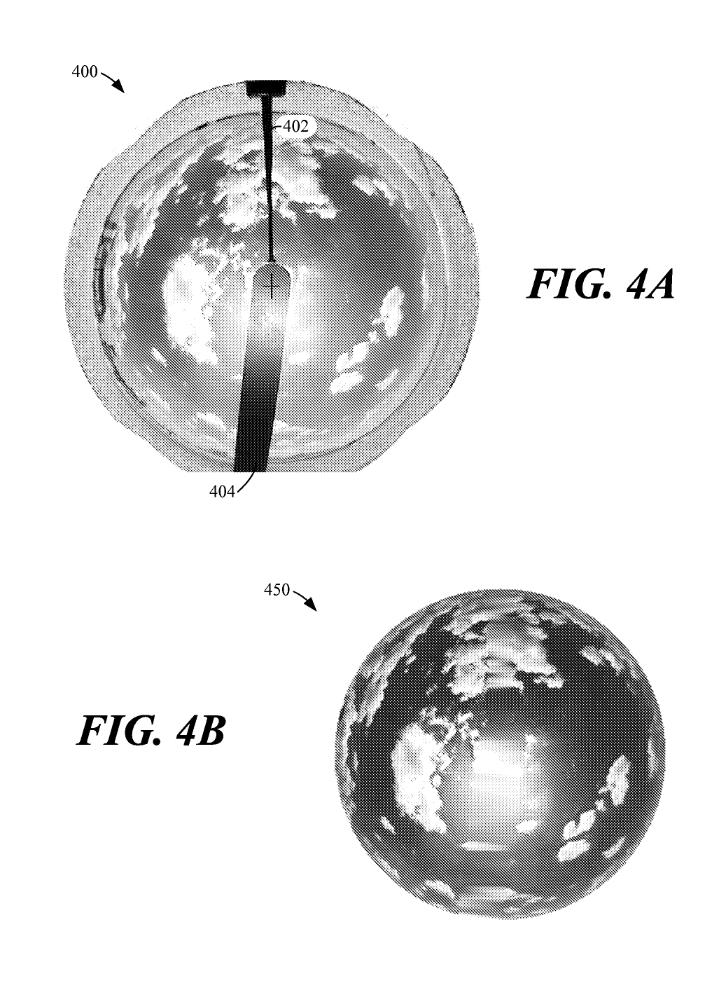

Turning back to FIG. 2, at reference numeral 206, the process 200 includes obstruction masking at least one sky image captured by the sky imager 170. In that context, FIGS. 4A and 4B illustrate an obstructed sky image 400 and a masked sky image 450, respectively. The masked sky image 450 is representative of the entire sky, without obstructions. Referring to FIG. 4A, it is noted that the TSI-440, as one example of the sky imager 170, places a camera above and facing down toward a reflective dome. This dome then reflects a 360 degree view of the sky back to the camera. Due to the nature of this construction, the camera arm 402 (and sometimes camera housing) may be a constant artifact in every sky image provided by the sky imager 170. As another example of a constant artifact, the obstructed sky image 400 includes the shadow band 404. In the TSI-440, the shadow band 404 is relied upon to block the high intensity of the sun in the sky so that the sensor of the camera is able to capture other details in the sky. As compared to the camera arm 402, the shadow band 404 does not remain in a fixed location among images.

Thus, at reference numeral 206, the image operator 132 is configured to mask obstructions, such as the camera arm 402 and the shadow band 404, to provide the masked sky image 450. The algorithm used to mask obstructions from sky images relies upon the obstructed sky image 400, the zenith and azimuth angle for the obstructed sky image 400, and center pixel x and y coordinates. In some embodiments, other user-determined variables may be set visually.

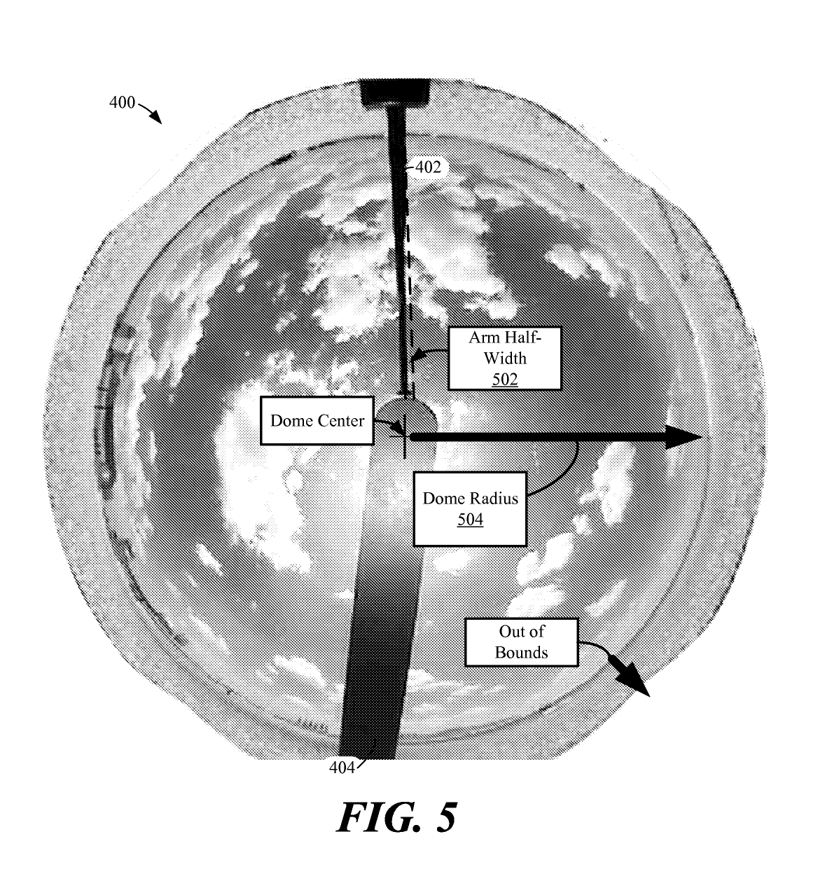

As can be seen in FIG. 5, the camera arm 402 stretches from the top of the obstructed sky image 400 to slightly beyond the center of the obstructed sky image 400. Its width is relatively constant except at the camera housing, for example, and it is usually very close to centered from left to right. A camera arm half-width 502 is used to set the distance from the center of the camera arm to either side. Another input is the dome radius 504. The dome radius 504 is the distance from the center of the image to the edge of the reflective dome. The dome radius 504 can be set visually by drawing concentric circles on top of the image until a circle fits exactly on the edge of the dome. The dome radius 504 is used in later steps to ensure that no time is wasted performing masking operations outside of the desired area.

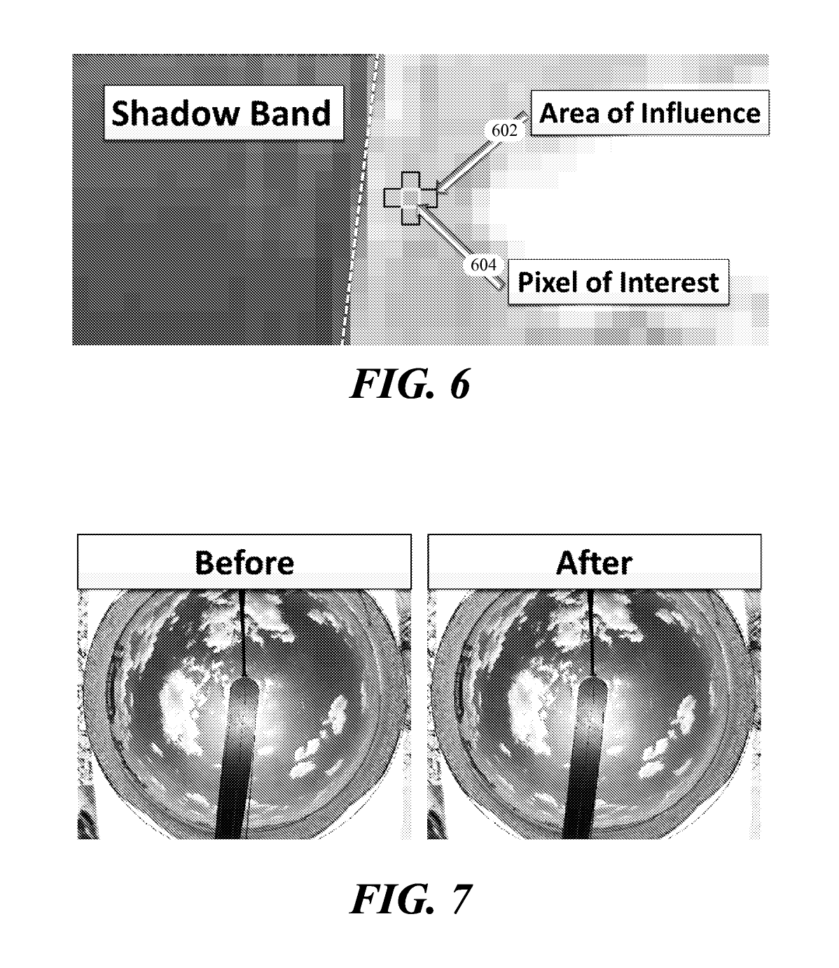

Referring to FIG. 6, another input for obstruction masking is the area of influence (AOI) 602. This value sets the number of pixels that will be used to determine the value assigned to the interpolation pixel. An AOI 602 of zero means that only the currently selected pixel is used for the interpolation value, and an AOI 602 of “n” means that “n” pixels to the left, right, top and bottom will be averaged with the pixel of interest 604 to determine the interpolation value. In FIG. 6, an example is shown using an AOI 602 of one. Thus, the four pixels in the AOI 602 and the pixel of interest 604 are averaged to determine the interpolation value. It is noted that other methods of AOI determination may be relied upon, such as including the diagonal cardinal points or having a discriminative intelligent pixel selection approach to distinguish cloudy/clear pixels.

Before assigning the desired interpolation areas, a correction may be made. For example, in the historical data 124, the value assigned to the azimuth angle may be identified using the current time stamp through the NREL SOLPOS calculator. The sky imager 170, on the other hand, may have its own algorithm to determine the azimuth angle. This algorithm controls the position and the movement timing of the shadow band. Ideally, the database value and the shadow band position would be synchronized, making the masking procedure fairly straightforward. Due to either the movement timing or the internal calculation, synchronization is unlikely. Therefore, the image operator 132 is configured to make a correction to the azimuth angle associated with each sky image captured by the sky imager 170. Referring to FIG. 7, in the “before” frame on the left, the misalignment of the shadow band with the SOLPOS calculated azimuth angle can be seen as compared to the “after” frame on the right.

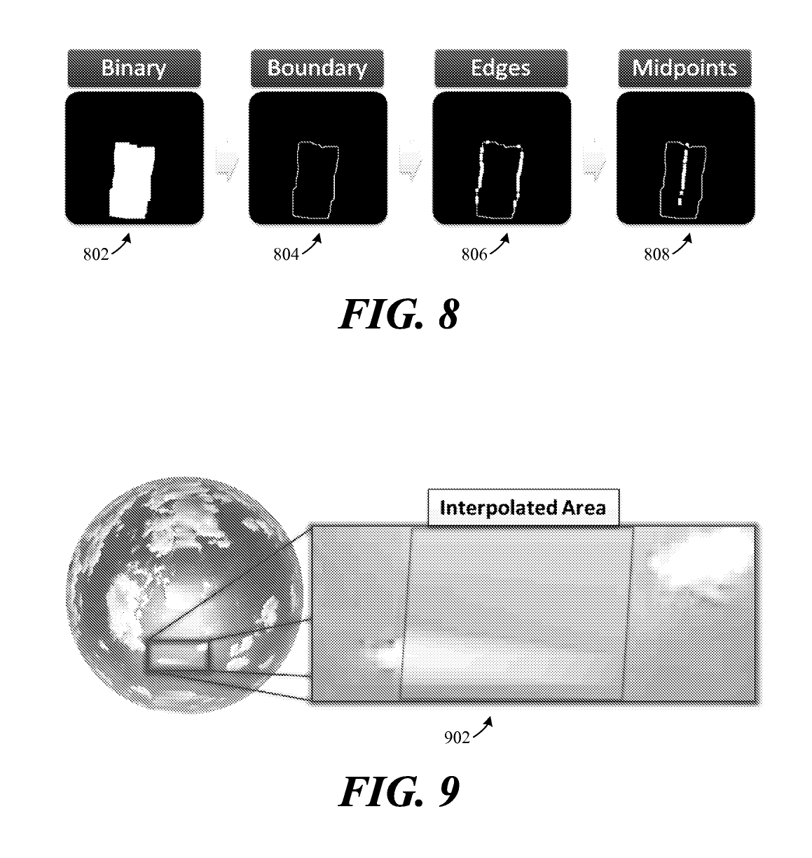

FIG. 8 shows the process used to adjust the azimuth angle to match with the shadow band. To detect the alignment of the shadow band, a binary image 802 is first generated by detecting only the shadow band in the image. Since the shadow band is seen as black, it stands out from the rest of the objects in the image, namely clouds. First the image was converted to gray-scale, then the binary image 804 was created by choosing a low threshold level close to zero, as intensities range from 0 to 255, with zero being black and 255 being white. Once the shadow band had been isolated in the binary image, the boundary 804 of the region was extracted.

Because the shadow-band alignment can be shifted either positively or negatively from the azimuth, a loop was performed starting at the center of the image and moving radially outward at the initial azimuth alignment once rotating clockwise until an edge 806 of the shadow band was reached and this value was recorded. The same was also performed for a counter-clockwise loop. The result of this procedure is a matrix that contained the radius and two edge points of the shadow band. From these points a midpoint 808 was determined. The median of all the midpoints would then be considered the new shadow band alignment azimuth. The new azimuth value may be used for masking but not to calculate irradiance or other ray-tracing operations as the value acquired from SOLPOS is more accurate.

Referring back to FIG. 7, the “after” picture shows the results of the azimuth adjustment process with the azimuth coordinates now matching the shadow band. The procedure can also be used to determine the shadow band half-width, which will be used in the calculation of the shadow band location grid, as described below. When the midpoint 808 (FIG. 8) of the edges was calculated, the distance to the farthest edge was also retained. This maximum half-width distance for the entire span of the shadow band can be used to set the half-width value.

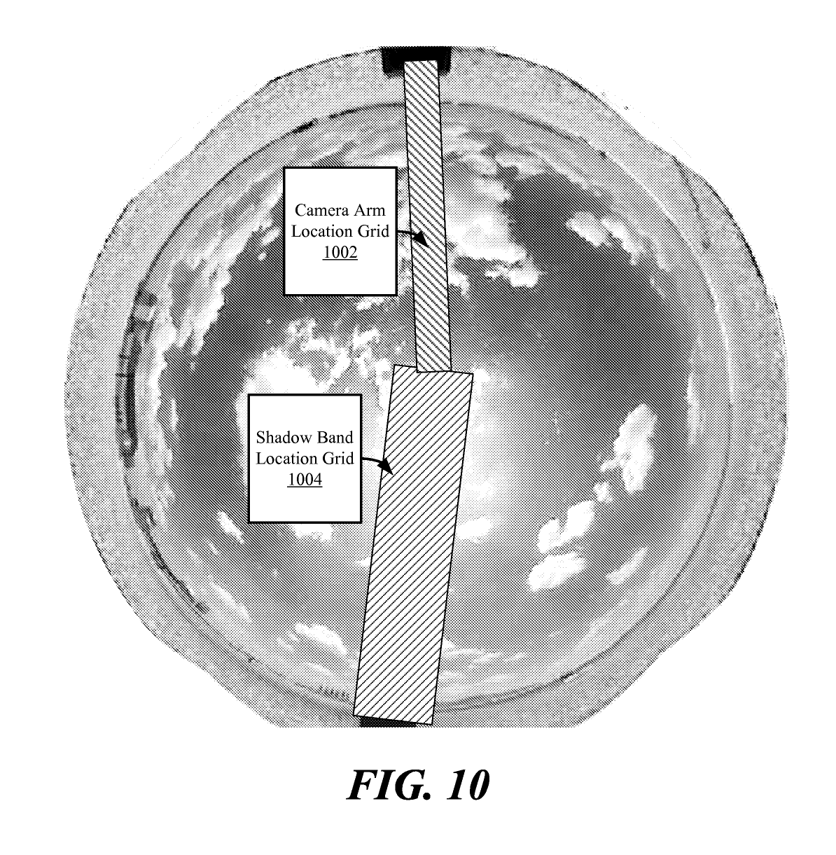

The interpolation method used in the obstruction masking relies upon a grid matrix of the area to be masked. In FIG. 10, example camera arm location grid 1002 and shadow band location grid 1004 areas are shown. To assign camera arm location grid 1002, an algorithm can be implemented that begins at the center of the image and ends at the out-of-bounds circle. The width of the grid can be set as twice the camera arm half-width 502 (FIG. 5) centered at the center of the image. For the shadow band location grid 1004, the new adjusted azimuth value can be used along with the shadow band half-width. Starting from the center and moving radially outward along the adjusted azimuth until the out-of-bounds circle, both left and right edge pixels can be recorded.

After the grid areas 1002 and 1004 are determined, the final step is to implement the interpolation of the regions. The interpolant can be expressed in the following form:

V_{q}=F(X_{q},Y_{q}), (1.1)

where V_{q} is the value of the interpolant at the query location and X_{q} and Y_{q} are the vectors of the point locations in the grid. When deciding on the method of interpolation to be used, it is noticed that a combination of two methods produced a more desirable result than either method alone. The first method is a standard linear interpolation shown in equation 1.2 below.

$$\frac{y - {y}_{0}}{x - {x}_{0}} = \frac{{y}_{1} - {y}_{0}}{{x}_{1} - {x}_{0}} , \qquad ( 1.2 )$$

where (x₀,y₀) & (x₁,y₁) are the two known points and the linear interpolant is the straight line between these points.

The second method provides a smooth approximation to the underlying function. The equation for this is as follows:

G(x,y)=Σᵢ₌₁ⁿwᵢf(xᵢ,yᵢ) (1.3)

where G(x,y) is the estimate at (x,y), wᵢ are the weights, and f (xᵢ,yᵢ) are the known data at (xᵢ,yᵢ). The weights are calculated from the ratio of the pixel intensities surrounding the desired pixel.

In various embodiments, either method may be relied upon. In one embodiment, the results of the linear and weighted interpolation methods are averaged together to create a smoothed interpolated region 902 as shown in FIG. 9. Using linear interpolation alone, a “streaky” interpolated result may prevail where clouds are horizontally smeared across the area. When using natural neighbor interpolation alone, a “blurred” and truncated cloud edge may appear where clouds met the interpolated region. The averaging of the two methods described above results in a better estimation of the underlying clouds.

The result of the obstruction masking provides the masked sky image 450 shown in FIG. 4B. After the obstruction masking, an unobstructed view of the sky is available for the remaining steps of the solar energy forecasting process 200. Before the obstruction masking, sky images captured by the sky imager 170 (FIG. 1) contain unable areas, such as the area covered by the shadow band. Through the obstruction masking, these areas are now “filled” with information, providing a more complete image of the sky. It is noted that some error may be introduced in the interpolated areas, although the error is acceptable for the purposes of the embodiments described herein.

Referring back to FIG. 2, at reference numeral 208, the process 200 includes geometrically transforming the masked sky image 450. Particularly, if the sky image 400 was taken from a reflective dome of the sky imager 170, the masked sky image 450 should be transformed to a flat image representative of the area of the sky photographed. Due to the minimal amount of curvature of the atmosphere at a diameter of 10 to 20 miles directly above the sky imager 170, it may be disregarded and assumed flat.

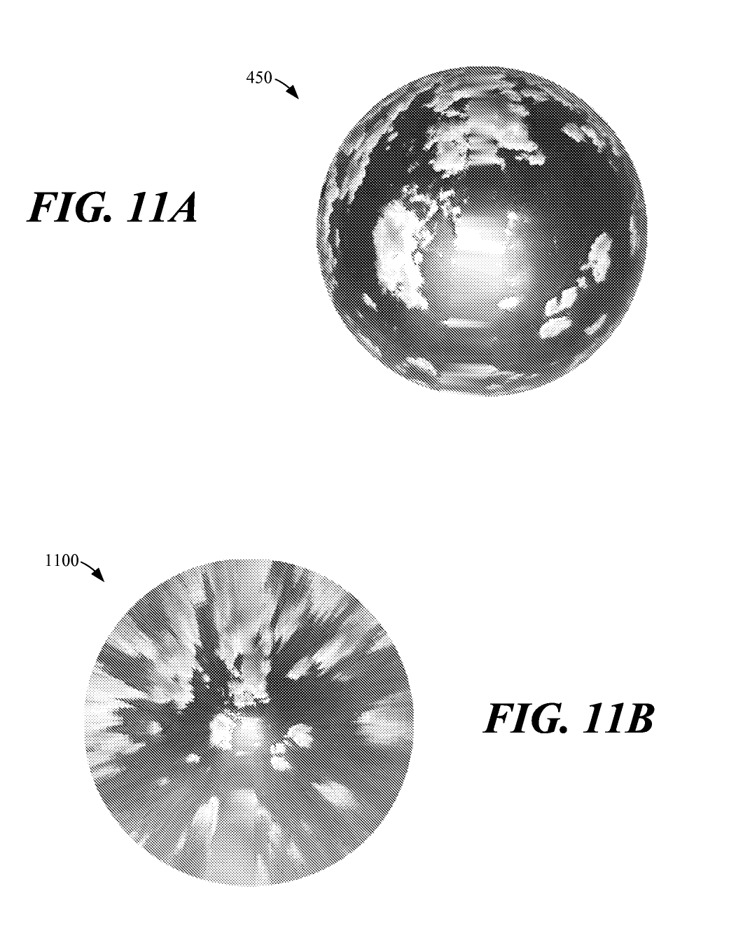

FIGS. 11A and 11B illustrate an example masked sky image 450 and corresponding flat sky image 1100, respectively, according to various embodiments of the present disclosure. The geometric transformation process at reference numeral 208 (FIG. 2) is performed by the image operator 132 of the solar energy forecast engine 130 and produces a flat sky image representative of what the sky looks like when transformed to a given cloud base height. The resulting, transformed image represents pixels in proportional (or nearly proportional) physical dimensions.

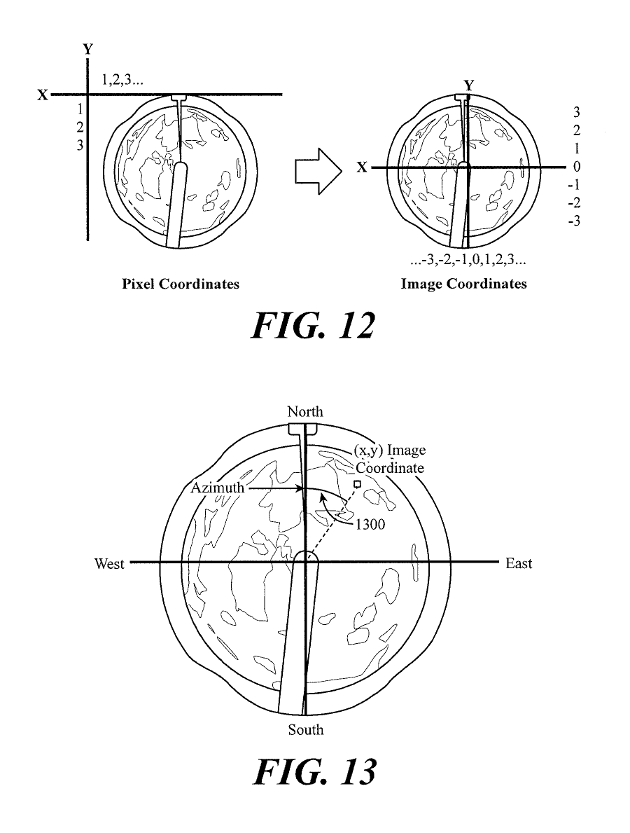

The first part of the geometric transformation process is focused on transforming the coordinates of the image from pixel based (e.g., x,y) coordinates to dome based (e.g., azimuth & zenith) coordinates. As shown at the left in FIG. 12, sky images are represented in pixel coordinates where x values begin at the leftmost pixel and increase to the right and y values begin at the uppermost pixel and increase downward. First, the pixel coordinates are repositioned based on a center pixel of the sky image, as shown at the right in FIG. 12. The right image in FIG. 12 shows both positive and negative x and y pixel coordinate values. The pixel coordinates are then located on the image sensor of the sky imager 170 as physical location coordinates. The final step is to calculate the azimuth and zenith angle of the dome based coordinates. Because the sky imager 170 uses a hemispherical dome reflector, the azimuth angle of an individual pixel for the image, the image sensor, and the dome-based coordinates can be calculated using the trigonometry of a rectangular (i.e., Cartesian) coordinate system.

Referring to FIG. 13, it can be appreciated how the azimuth angle 1300 is calculated in degrees from north by the following formula:

$$azimuth = {tan}^{- 1} ( \frac{x}{y} ) . \qquad ( 1.4 )$$

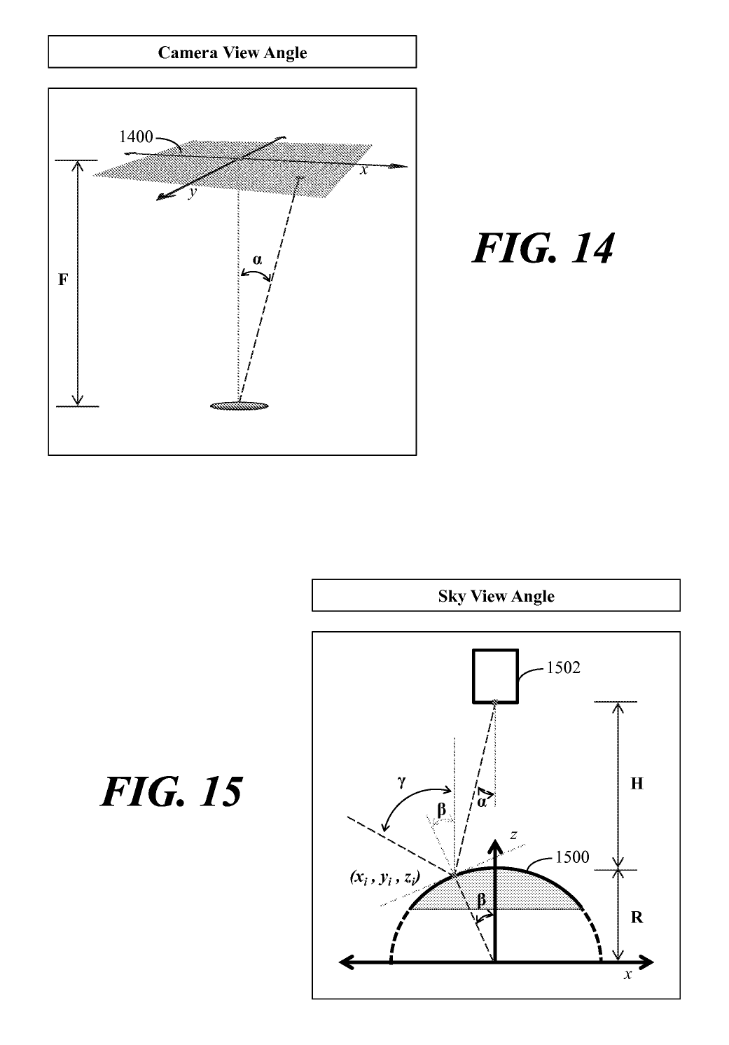

The zenith angle calculation of individual pixels from the image sensor coordinates to image-based coordinates requires a conversion of the dome reflector's three-dimensional polar coordinates into rectangular coordinates. It is broken down into two steps, the first of which is determining the camera view angle a from the point of view of the image sensor 1400, as shown in FIG. 14. This angle a can be calculated from the physical coordinates on the image sensor 1400 using the following formula:

$$α = {tan}^{- 1} ( \frac{\sqrt{{x}^{2} + {y}^{2}}}{F} ) , \qquad ( 1.5 )$$

where the distance F is the focal length and α is the camera view angle.

The second step is to use the camera view angle α from Equation 1.5 to represent the sky view angle of the hemispherical dome. Due to the symmetry of the hemispherical dome 1500, the geometry can be represented in two dimensions as is shown in FIG. 15. In order to calculate the value of zᵢ on the hemispherical dome 1500, it is necessary to combine the two equations 1.6 and 1.7 below into the quadratic equation 1.8. Equation 1.6 is as follows:

$$z = \frac{- \sqrt{{x}^{2} - {y}^{2}}}{tan α} + H , \qquad ( 1.6 )$$

where z is the distance down from the camera housing 1502 to the point on the dome surface, x is the horizontal distance from the camera lens to the point on the dome surface, α is the camera view angle calculated in the previous step, and the distance H is the distance from the camera lens to the top of the dome surface. Equation 1.7 is the equation for a circle:

x²±y²±z²=R², (1.7)

where R is the radius of the sphere from which the hemisphere was cut. The combined equation results in the following quadratic:

zᵢ²(tan² α+1)−z(2H tan² α)+H² tan² α−R²=0. (1.8)

Solving Equation 1.8 for zᵢ is the vertical distance from the center of the hemispherical dome 1500 to the dome surface. Now that the value of zᵢ is known, β and γ can be solved by the following two equations:

$$\begin{matrix}β = {cos}^{- 1} ( \frac{{z}_{i}}{R} ) and & ( 1.9 ) \\ γ = 2 β + α . & ( 1.10 )\end{matrix}$$

The value γ calculated in Equation 1.10 is the zenith angle.

Table 1 summarizes the parameters and values applied for the calculations of the coordinate systems transformation using the TSI-440 sky imager. Other sky imagers would need similar coordinate transformations depending on the geometry of the mirror or camera lens (e.g., fisheye lens, etc.).

TABLE 1
TSI-440 parameters used in coordinate system transformation

| Sky Imager Property | Value Used | |
|---|---|---|
| Camera Image Sensor | Micron ¼-Inch VGA CMOS | |
| Active Imager Size (X, Y) | (3.58 mm, 2.69 mm) | |
| Focal Depth (F) | 4.00 | mm |
| Camera to dome separation (H) | 16.17 | in |
| Dome Radius (R) | 9.00 | in |

Following the procedures described above, it is possible to determine azimuth and zenith values for each pixel in a sky image captured by the sky imager 170. The azimuth and zenith values are used to convert original, hemispherical sky images to a flat sky images.

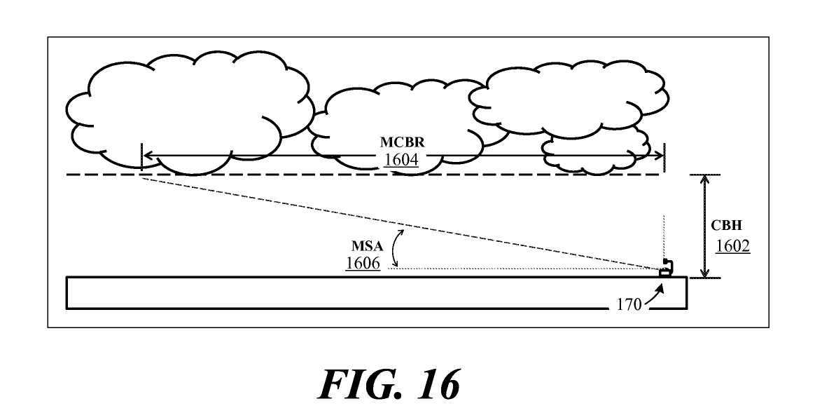

The following image transformation procedure, performed by the image operator 132 (FIG. 1), projects original, hemispherical sky images to flat sky images based on a given height known as the cloud base height (CBH). Referring to FIG. 16, the CBH is designated reference numeral 1602. To begin, the maximum cloud base radius (MCBR) 1604 is be calculated. The value of the CBH 1602 is retrieved from the historical data 124. The minimum sky altitude (MSA) 1606, also illustrated in FIG. 16, is a user defined value. The MSA 1606 determines how large the radius of the resulting sky image will be. If the MSA 1606 is set to zero degrees, the radius of the sky image would be infinite. To capture the majority of the sky from a sky image but not create a radius that is too large, the MSA 1606 may be set about 10 degrees, although other values of the MSA 1606 are within the scope of the embodiments. According to Equation 1.11, the MCBR 1604 is calculated as:

$$MCBR = CBH * tan ( \frac{π}{2} - MSA ) . \qquad ( 1.11 )$$

The size of each pixel in feet (PXf) is then calculated as:

$$PXf = \frac{MCBR}{SPr} . \qquad ( 1.12 )$$

The sky image pixel radius (SPr) is another user determined value. For example, the resulting sky image may be set to have a 500 pixel by 500 pixel resolution. Thus, the SPr is equal to 250, although the use of other values is within the scope of the embodiments.

Due to the symmetry of the dome and, hence, the resulting sky image, a representative “slice” of zenith angles is taken from the center of the image to the edge of the out-of-bounds circle. The slices are used when matching a dome coordinate zenith angle to a sky coordinate zenith angle. The process is done in a reverse fashion, meaning that, for each pixel in the resulting sky image, a corresponding pixel from the original image must be found.

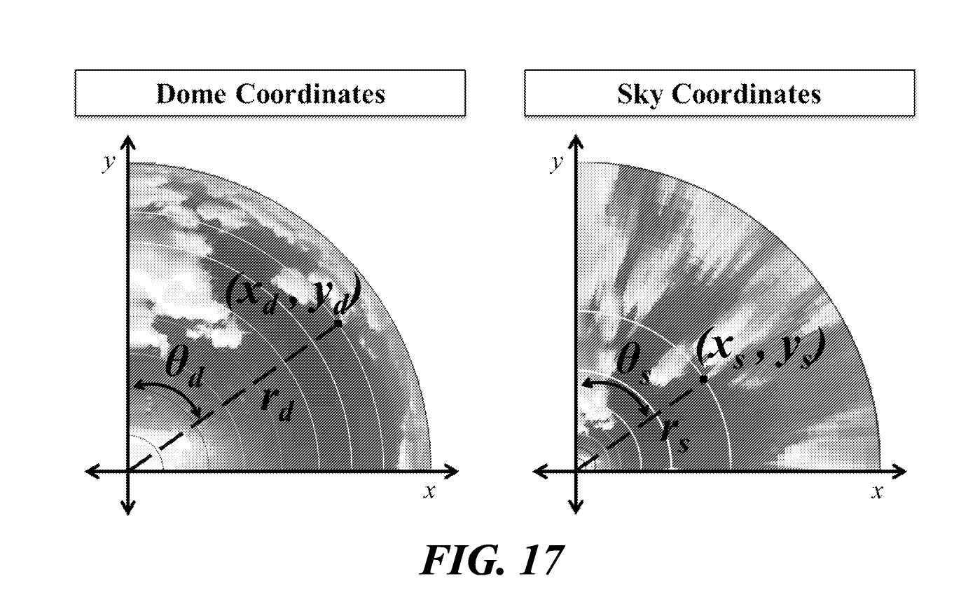

FIG. 17 shows how each pixel in the sky coordinate system (xₛ,yₛ) is matched with a corresponding pixel in the dome coordinate system (x_{d},y_{d}). The azimuth angle is equal in either coordinate dimension, i.e., θₛ=θ_{d}. The zenith angle transformation again relies upon more calculations where the radius of the sky image pixel coordinate r_{d} is a function of the radius of the dome image pixel coordinate rₛ, as described in the following equations:

$$\begin{matrix}{r}_{s} = \sqrt{{x}_{s}^{2} + {y}_{s}^{2}} and & ( 1.13 ) \\ zenith = \frac{π}{2} - {tan}^{- 1} ( \frac{{r}_{s} * PXf}{CBH} ) . & ( 1.14 )\end{matrix}$$

The value of zenith calculated in Equation 1.14 is then iteratively matched against the zenith angle slice acquired in the previous stage. The closest matching value will be the r_{d} value from which (x_{d},y_{d}) can be calculated using the following two equations:

x_{d}=r_{d}*sin θ_{d} and (1.15)

y_{d}=r_{d}*cos θ_{d}. (1.16)

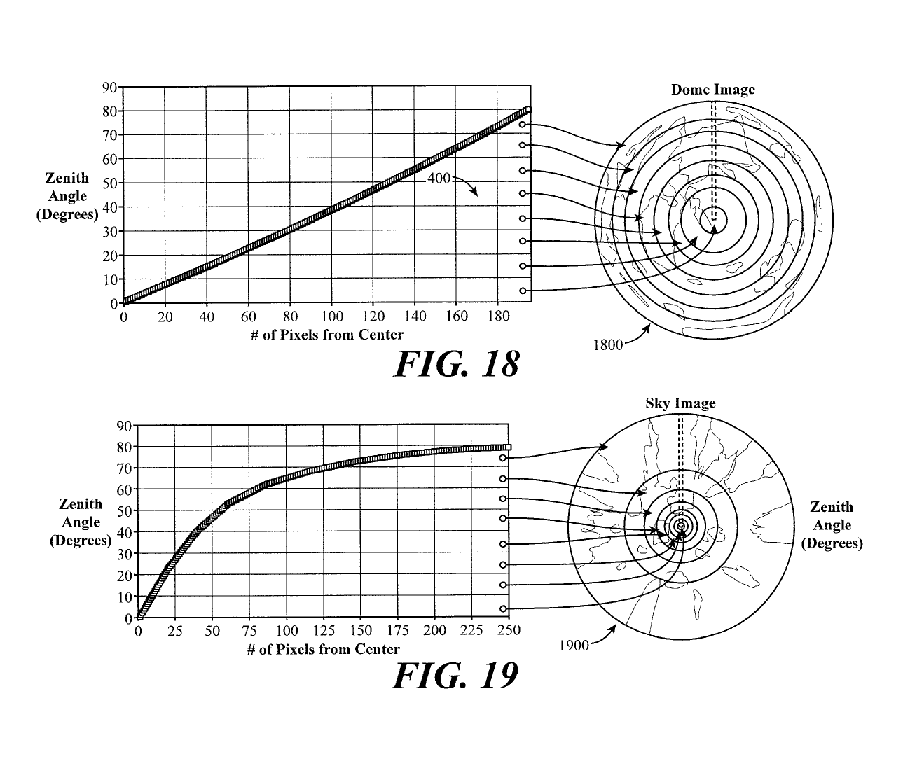

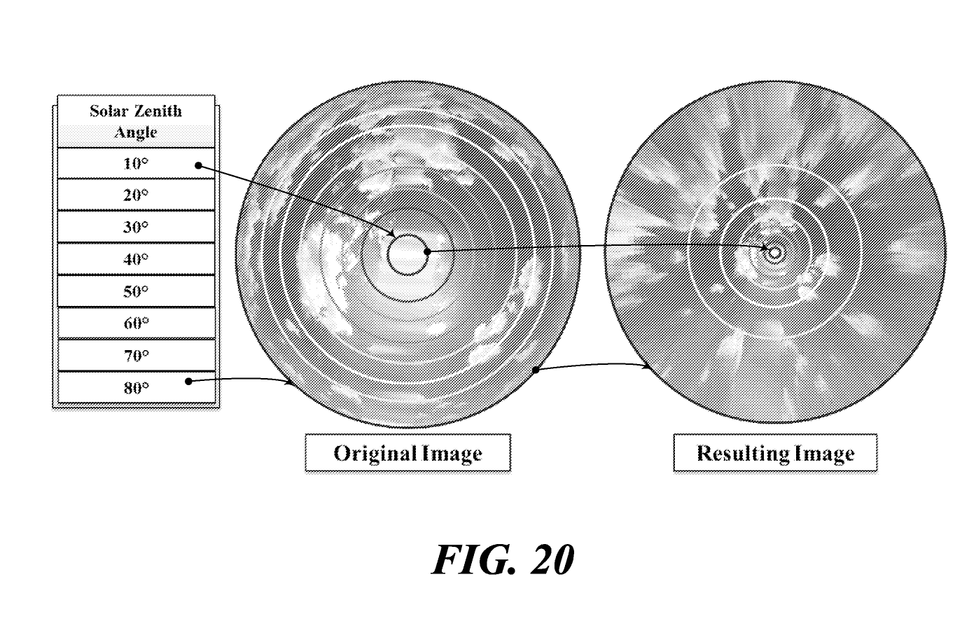

Using this procedure, every pixel in a resulting sky image can be populated by its respective, original sky image pixel information. FIGS. 18 and 19 show sky images coupled with a graph of the pixel to zenith correlations. In the original “dome” sky image 1800, each pixel represents the same relative zenith distance, while in the resulting “flat” sky image 1900, each pixel represents the same relative distance in feet. FIG. 20 shows the effect that the transformation has on clouds within the image. In the resulting “flat” sky image 1900, clouds closer to the center of the image are shrunk and moved closer, whereas clouds that are on the edges of the image are stretched and become a larger portion of the image.

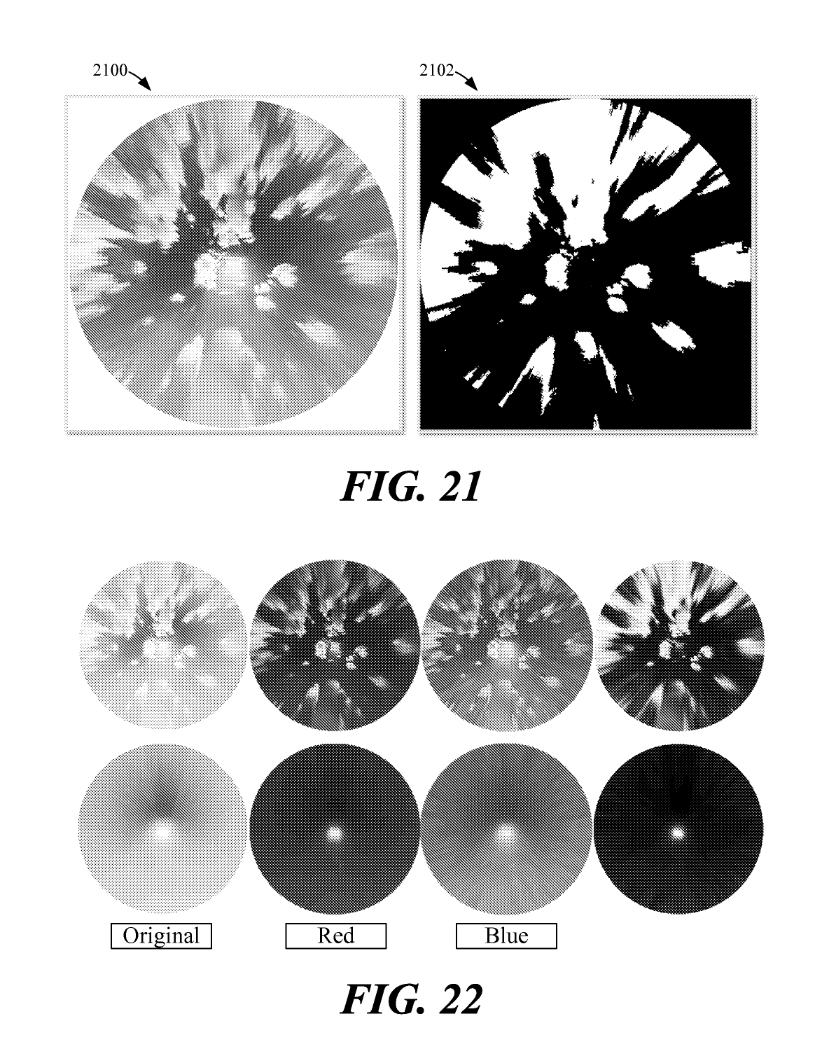

Referring back to FIG. 2, the process 200 now proceeds to reference numeral 210, which includes identifying at least one cloud in one or more flat sky images. The cloud detector 134 (FIG. 1) may perform a process of detecting clouds. In order to determine cloud motion and project cloud shadows onto the ground, the embodiments described herein create a binary image representing only the clouds in the given image. This binary image can assign a value of one to clouds and a value of zero to areas of clear sky. In this context, FIG. 21 illustrates a binary image representing only clouds in a sky image. In FIG. 21, the image 2100 on the left is a current sky image after obstruction masking and geometric transformation and the image 2102 on the right is the binary representation of the cloudy regions in the image 2100.

One way to perform the process of detecting clouds is to compare a sky image including clouds with that of a clear sky. A database of clear sky images for comparison may be stored in the sky images 122, as described above. For a current sky image, the cloud detector 134 searches through the zenith binned clear sky match database for the closest matching zenith and azimuth angle. In one embodiment, priority is given first to matching the closest azimuth angle and then to the zenith angle, as it is important for sun scattering to be in a relatively same location.

A clear sky will reflect more blue light than red light and thus have greater blue intensities than cloudy areas, which makes the red to blue ratio a good indicator for segmenting clouds against a clear sky. Thus, the next step in the process is to acquire the red to blue ratio for both images. To take full advantage of the range of grayscale intensities from 0 to 255, the range is split into two. When red intensities are less than blue intensities (clear sky), a value from 0 to 127 is assigned. When red intensities are greater than blue intensities (cloudy) a value from 129 to 255 is assigned. This method assures that low intensity values are clear and high intensity values are cloudy. The value of 128 is reserved for when red and blue intensities are equal. This results in the following three equations, where rbr is the red to blue ratio:

$$\begin{matrix}If red > blue \text{:} rbr = 129 + ( \frac{\frac{red}{blue}}{{max ( \frac{red}{blue} )}^{- 1}} ) * 127 , & ( 1.17 ) \\ If red < blue \text{:} rbr = 127 - ( \frac{\frac{red}{blue}}{1 - min ( \frac{red}{blue} )} ) * 127 , and & ( 1.18 ) \\ If red = blue \text{:} rbr = 128. & ( 1.19 )\end{matrix}$$

The results of these equations can be seen in the images in FIG. 22, which shows original, red, and blue intensity clouded and clear sky images. From FIG. 22, it is noticeable that the clouds in the upper right image appear very bright white, because Equation 1.17 represented them that way. The image to the far right in FIG. 22 is the red to blue ratio of the clear sky matching image, and Equation 1.18 shows the majority of the image as dark (the blue intensities are much larger than the red intensities), with the exception of the bright white sun near the center.

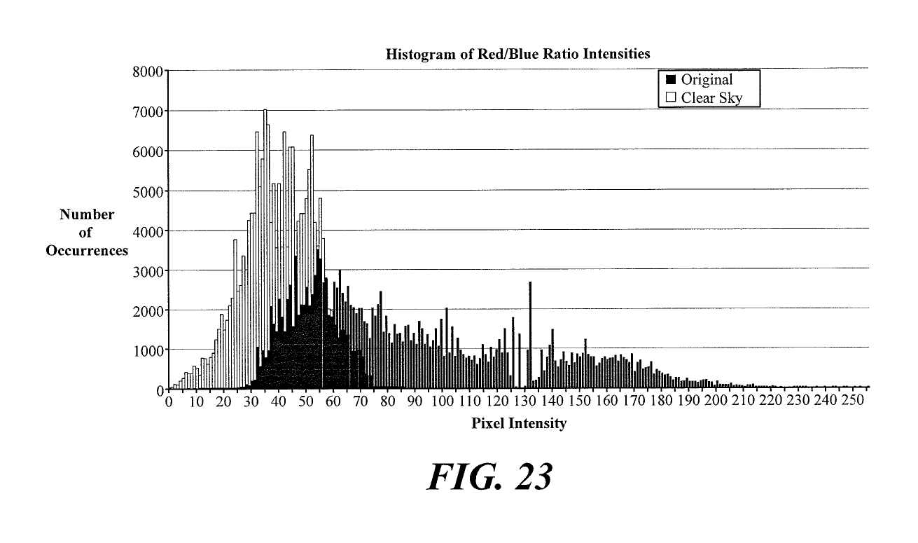

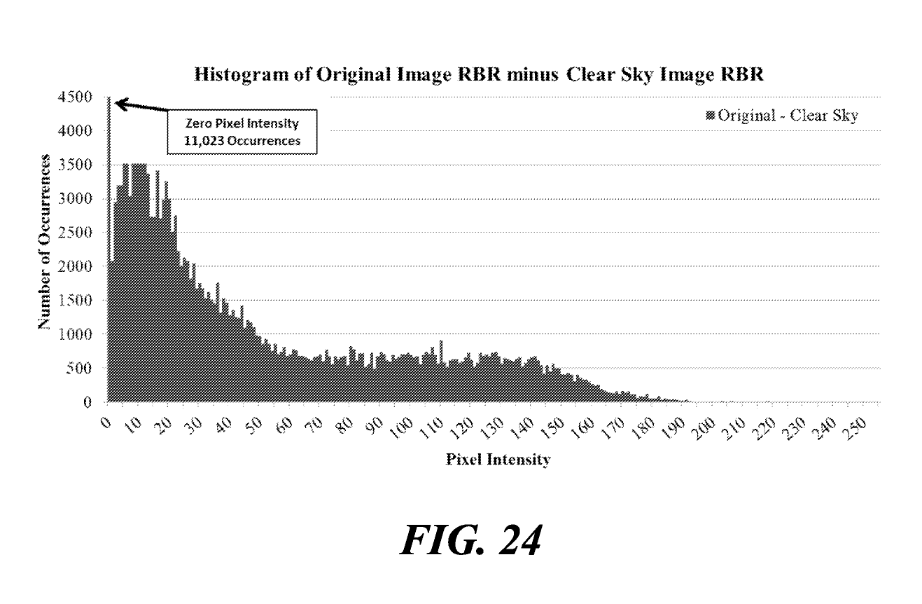

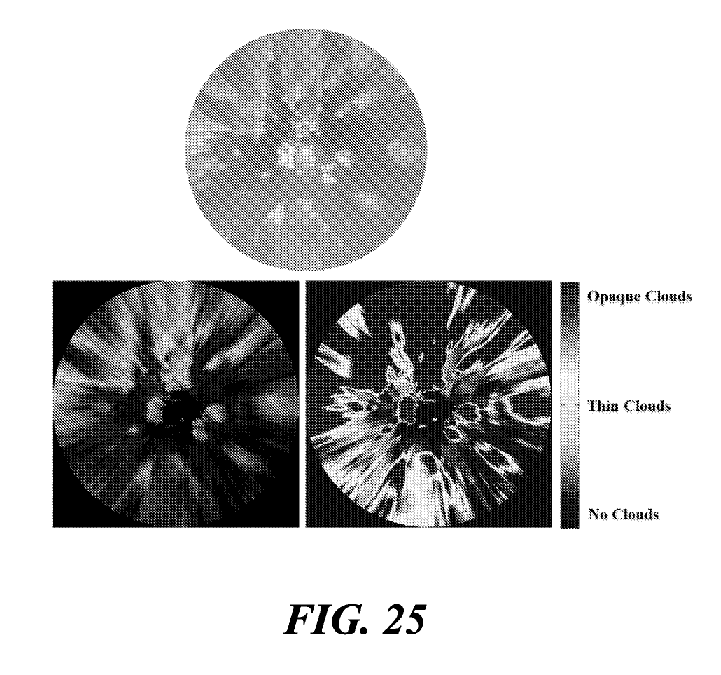

After red to blue ratios have been calculated for both a current sky image and its corresponding clear sky matching image, the subtraction of the two images helps to isolate the clouds. As can be seen in the histogram in FIG. 23, the majority of the clear sky red/blue ratio intensities are at the lower end of the intensity scale, while the original image is spread out along the range of intensities. If the clear sky image is subtracted from the original image, all that may remain in the resultant image would be cloudy areas, with the clear sky areas having been zeroed out. FIG. 24 shows the histogram of the image that results from the subtraction process. More than 11,000 occurrences of zero intensity value exist, but this graph was truncated to make the remaining data points more prominent. The high occurrence of zero values and values near to zero indicate that a large portion of the image has a clear sky. In a resulting image from the subtraction of the clear sky red/blue ratio from the original image red/blue ratio, as illustrated in FIG. 25, the darkest areas of the image indicate areas with no clouds, and lighter areas indicate dense clouds.

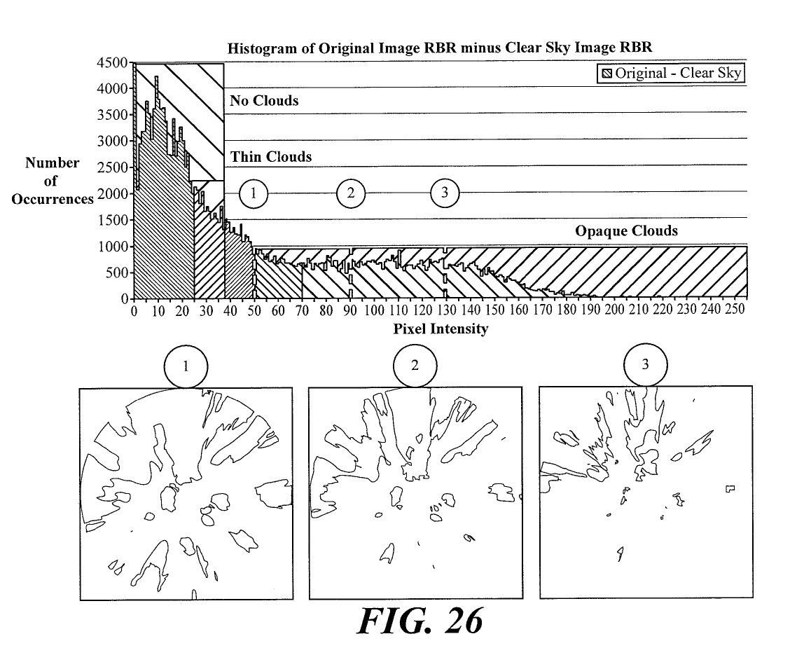

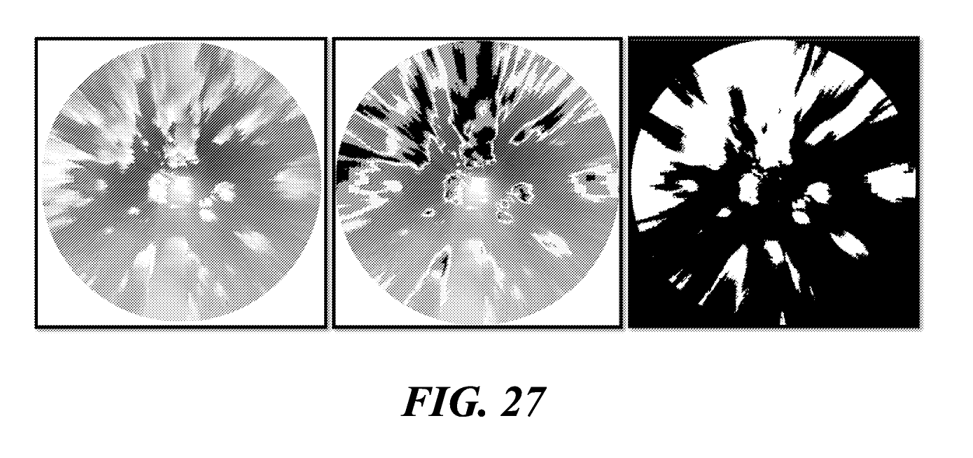

The final phase in the cloud detection process is the selection of threshold limits that will decide the cloudy regions in the binary image. A number of different thresholds may be used among the embodiments to account for density variability in clouds. These thresholds have distinct effects on the irradiance intensity coming through the cloud layer. In the histogram in FIG. 26, it can be seen that the boundaries for different cloud conditions are not clear, but have some overlap. For the purpose of cloud motion and ray tracing, the first layer of segmentation (1) is at the border of possibly opaque clouds and in the middle of the possible range of thin clouds. Layers (2) and (3) are chosen deeper in the opaque range to assist in making more accurate irradiance calculations. The images shown at the bottom of FIG. 26 represent the binary image created from segmenting layers (1), (2), and (3) at each of these threshold levels. It is easy to see that the less dense areas are more populous and the denser areas less populous. Finally, in FIG. 27, the resulting segmented image is shown side by side with the original image for verification of the cloud detection process.

To make predictions of solar irradiance, certain embodiments follow the future location of clouds. In intra-hour forecasting, for example, one method involves obtaining the general motion of all the clouds, calculating the cloud cover percentage, projecting all the clouds linearly into the future, and calculating the change in cloud cover percentage. Another method depends on finding the general direction and then analyzing a narrow band of sky in the direction of approaching clouds. That band is separated into regions, and the cloud coverage for each region is calculated. The regions are then projected into the future in the general direction to determine a future cloud coverage value.

According to aspects of the embodiments, motion as well as shape characteristics of individual clouds are followed to make future predictions of cloud locations. Particularly, at reference numeral 212 in FIG. 2, the process 200 further includes determining the motion of one or more clouds in sky images. Prior methods of analyzing cloud motion consisted of treating an entire cloud base as one object and displacing the entire object linearly to make predictions. In the embodiments described herein, clouds are treated as individual specimens that can have different trajectories and change shape and size. Thus, the embodiments described herein capture more of the dynamics involved in cloud formation and dissipation. The method consists of three main steps including acquiring the general motion of individual clouds, acquiring the individual motion vector of the individual clouds, and creating a new sky image at a given time in the future. Using this method, the resulting future sky images are more representative of the actual future sky conditions.

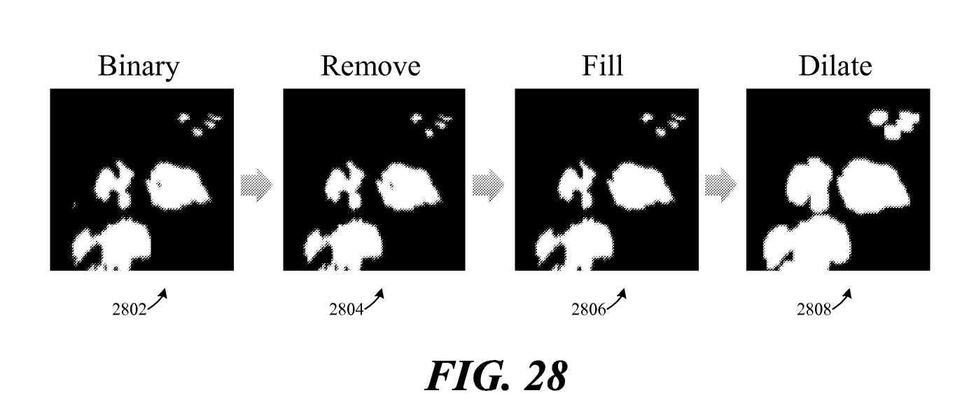

The determination of clouds in sky images may be performed by the cloud detector 134 (FIG. 1). As mentioned above, the first step in the process includes acquiring the general motion of individual clouds in a sky image. The general motion will be used to define the search path in which to look for individual cloud matches. To find the general motion of the clouds, processing must be performed on segmented binary cloud images. This processing is shown in the flow chart in FIG. 28. The binary image 2802 shows a portion of the segmented binary image, and the next image 2804 is the same image with all regions with an area smaller than 10 pixels removed. The removal is barely noticeable in the image but may be relied upon to simplify the process. The image 2806 shows the results of filling any holes within a detected cloud. This is done so that holes in a cloud are not detected as separate regions. The image 2808 shows when all regions (clouds) have been dilated. The dilation adds one extra pixel to the boundaries of any region. The dilation may be performed in order to group together small, nearby segments of cloud and make the edges of the clouds smoother and thus more recognizable. In the case of general motion, the dilation may be performed a number of times, such as two to five, for example, to simplify the cloud matching process.

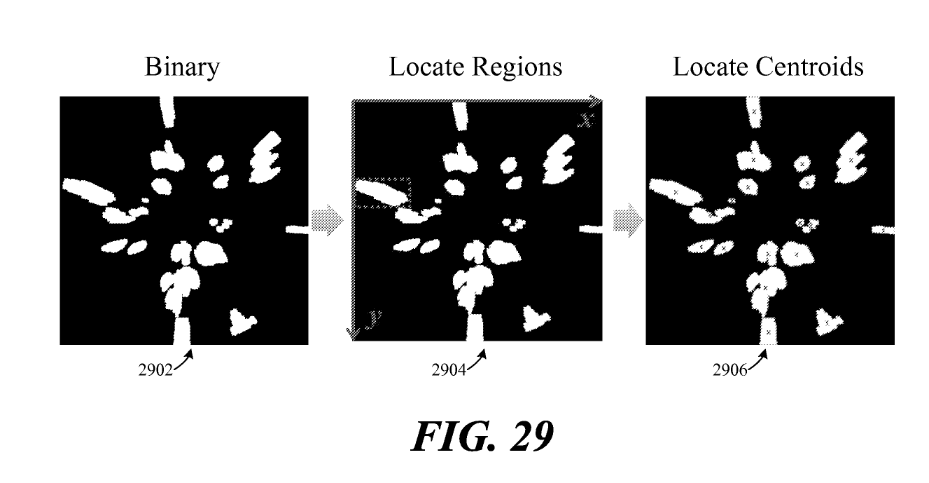

After a segmented binary cloud image has been cleaned, the next step is to locate each individual region and its characteristics, such as its boundaries, bounding box and centroid. FIG. 29 illustrates this process in a flow chart, where the cleaned binary image is shown at 2902. At 2904, the middle image shows the process of detecting each region, starting from the upper left pixel of the image and scanning the y axis from top to bottom and the x-axis from left to right. When the scan locates the first binary-one pixel, it creates a bounding box which includes the binary region until there are no more binary-one connected pixels. This process is repeated until all binary regions are bounded. At the same time, the centroid and boundaries of the region are calculated at 2906 for each bounded region.

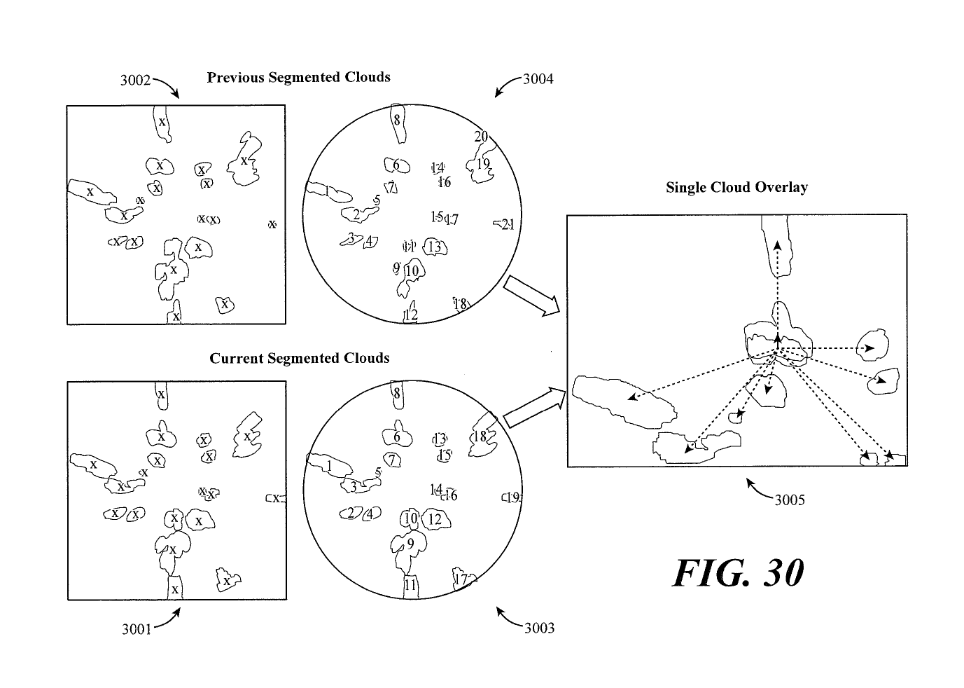

The next step in the process now involves the image one time step before the current image, in order to detect the motion of the clouds. In this forecasting process, images may be collected at thirty second (or other) intervals. Therefore, the general motion discovered will be for that time period. FIG. 30 shows the cleaned binary segmented cloud images for the current time 3001 and also one time step earlier 3002. The middle images 3003 and 3004 show cloud regions labeled individually. The far right image 3005 in FIG. 30 shows a single cloud from the previous image overlaid on top of the current image.

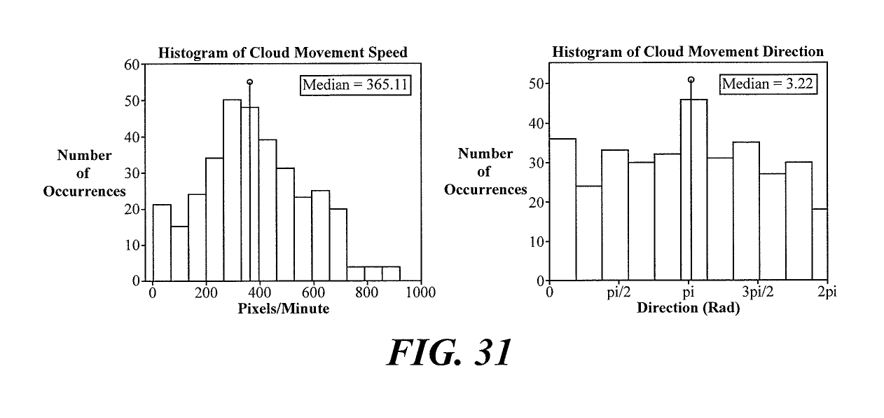

To determine the general direction of clouds in images, each cloud in the previous image is overlaid on to the current image and the motion (e.g., distance and direction) of one or more clouds in the current image is calculated. This process is repeated until each cloud (or as many as desired) in the previous image has been overlaid. The result is one or more matrices, each with m rows and n columns, where m is the number of cloud regions in the previous image and n is the number of cloud regions in the current image. FIG. 31 shows the two histograms that result from the matrices described above. These histograms include the results of all cloud to cloud measurements. Thus, the median values do not accurately represent the general direction.

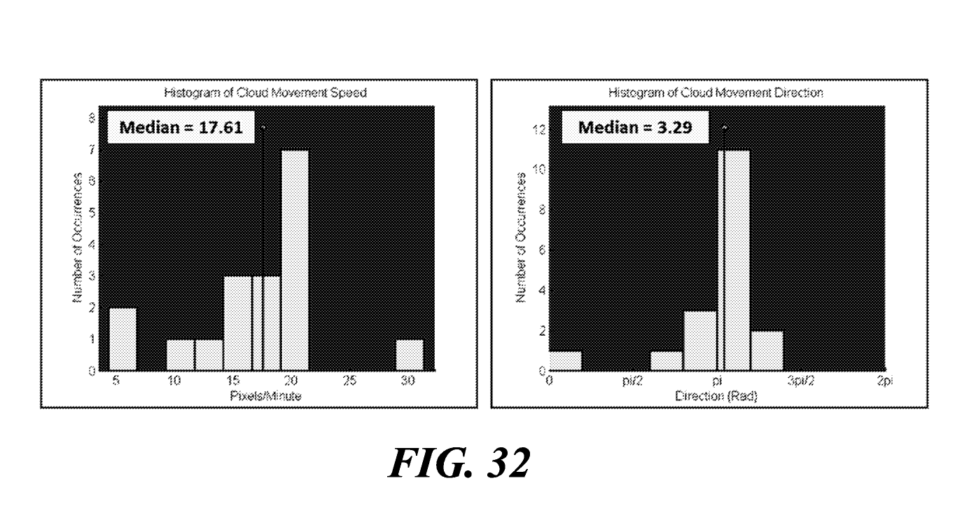

In most cases, it can be seen that the desired matching cloud is the shortest distance away from the reference cloud. For this reason, a new histogram should be made that includes only the closest centroid distance for both the movement speed and direction. FIG. 32 shows the new resulting histogram when only the closest matching centroids are kept. The median values acquired from these histograms much more closely resemble the actual general motion of all clouds. From FIG. 32 we see that the clouds have a general movement speed of 17.61 pixels/minute and a general direction of 3.29 radians. The direction is represented in standard meteorological terms whereby the general direction represents the direction from which the clouds are coming, approximately from the south/southwest.

One final improvement may be made to the general motion assumptions, since the values acquired when choosing the closest centroid match may not, in fact, be the correct cloud. This correction involves the general motion characteristics from the previous time period. In one embodiment, to remain as a correct cloud match, the direction should be within π/4 radians of the previous general direction and the movement speed should be less than 2 times the previous general movement speed. The assumptions are made because the direction and speed of the clouds should not change very rapidly in a 30 second interval.

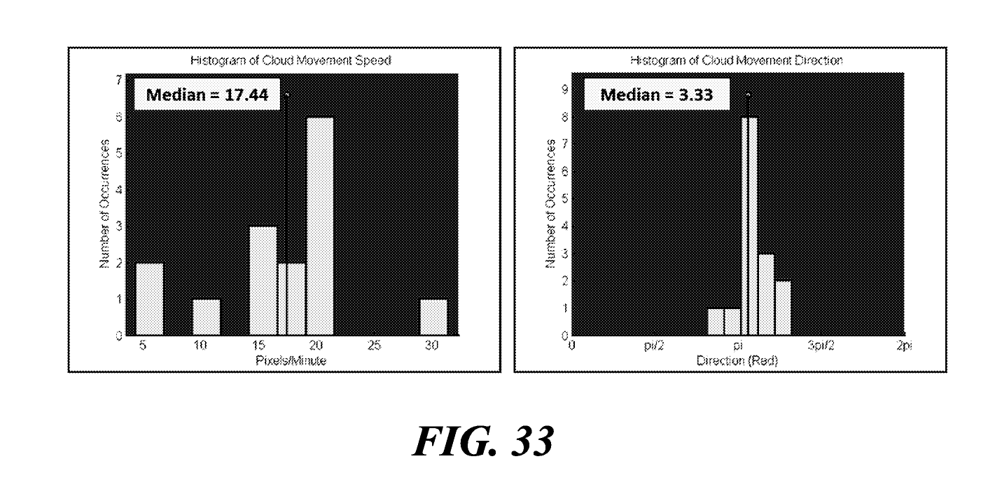

FIG. 33 shows the resulting histogram when these changes are applied. The changes can be seen noticeably in the cloud movement direction histogram (right) where the outlying values have been removed. The overall result is an improved movement speed of 17.44 pixels/minute and movement direction of 3.33 radians. After the general direction for current clouds has been established, the following procedures will generate the motion characteristics of each individual cloud. To begin the procedure, the original binary segmented cloud image will go through the same cleaning procedure as during the general motion calculation, namely removal, filling, and dilation. The only difference in the cleaning procedure is that the dilation will be performed once instead of three times. In this case, some of the clouds may remain as separate entities, which allows the individual cloud motion to be calculated for more clouds, thus resulting in greater accuracy. When comparing with the previously-detected clouds, additional clouds may be recognized due to the smaller dilation amount.

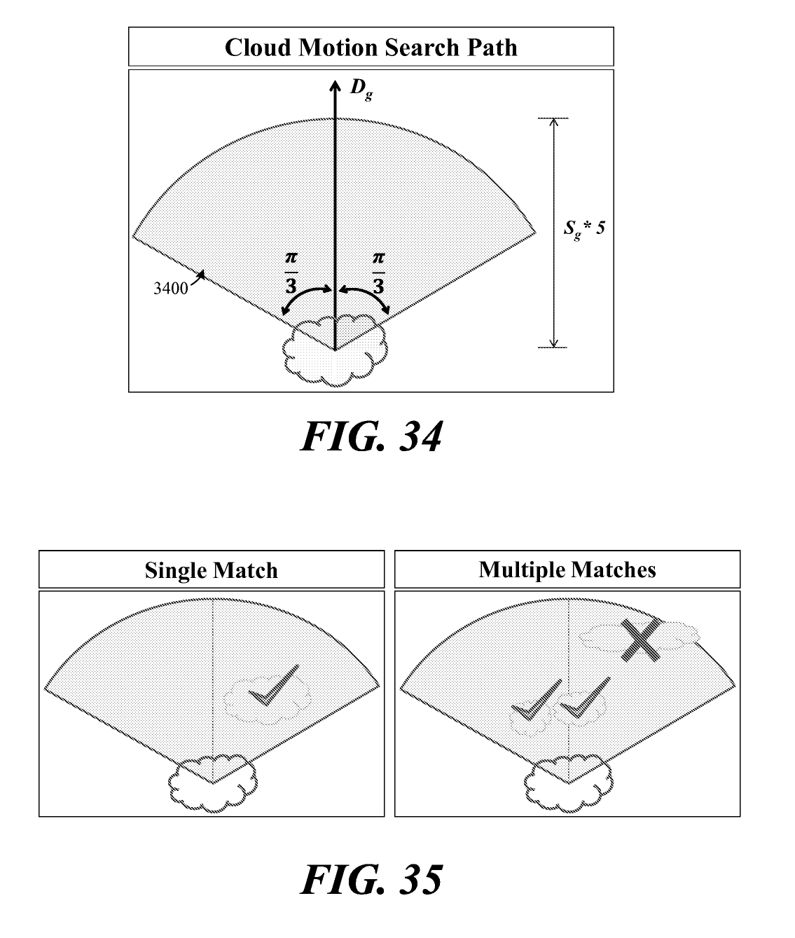

With the cloud regions and general motion characteristics detected, the process to locate an individual cloud match can begin. The first part of that procedure is to define the cloud motion search path, as shown in FIG. 34. When a previous cloud is overlaid over the current image, a search path is defined at the cloud centroid. The search path begins at the centroid and extends in the general direction D_{g} to a distance of 5 times the general speed S_{g}. The search path 3400 encompasses a radial width of π/3 radians (equivalent to +/−60 degrees) to either side of D_{g}. The purpose of the search path 3400 is to exclude clouds that lay beyond this region from the cloud matching process.

FIG. 35 shows a theoretical sample result of clouds detected in the search path. On the left side, one cloud is detected within the search path and is therefore determined to be the matching cloud. On the right side, there are three clouds recognized in the search path. In this type of situation, further analysis needs to be performed to correctly match the clouds. The extra analysis involves summing the area of all the clouds in the search path and comparing it to the area of the current cloud. If the summed amount of clouds is greater than 1.25 times the current cloud area (>25% larger), for example (or another similar metric), then the furthest cloud is removed and the cloud area is summed again. This process is repeated until the summed clouds are less than 1.25 times the current cloud area. In FIG. 35, this procedure is shown in the right-most image, where the cloud furthest from the center has an “X” through it indicating that the summed area was too large and, therefore, as the furthest cloud it will be removed. The remaining two clouds have a total area less than 1.25 times the current cloud area and both clouds are therefore determined split from the original cloud.

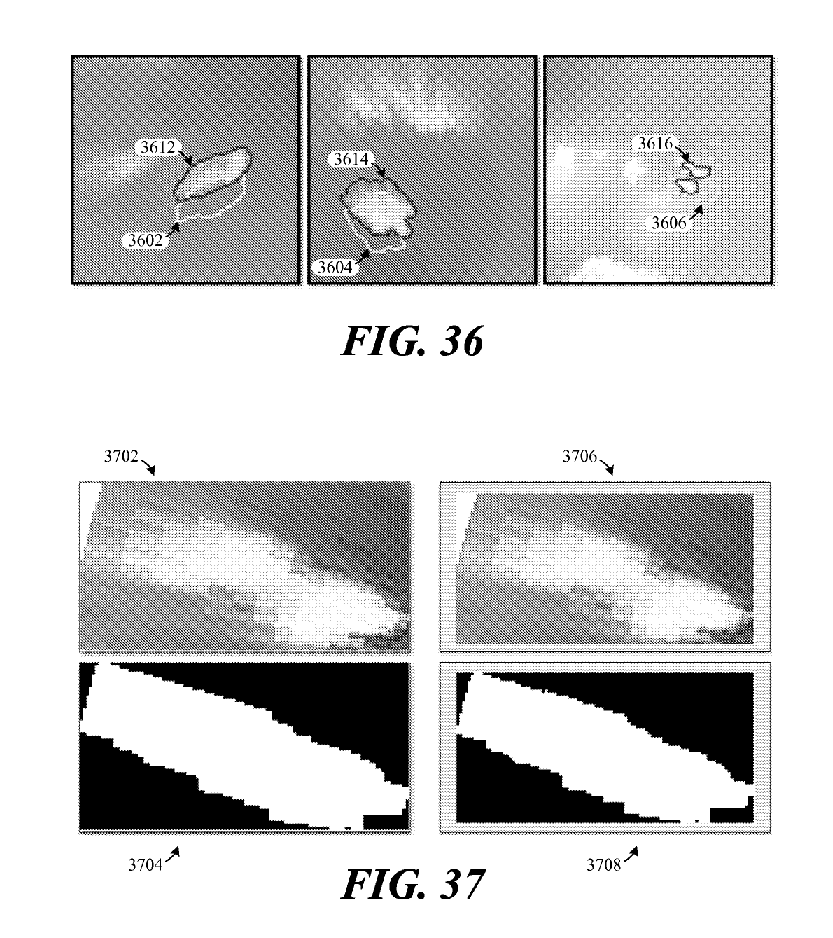

FIG. 36 shows the results of the cloud matching process, where the regions 3602, 3604, and 3606 are representative of the previous positions of clouds and the regions 3612, 3614, and 3616 are representative of the current positions of clouds. The leftmost and middle images show the detection of single cloud matches, and the image on the right shows an example of a current cloud with two matching results. During the matching process, the direction, speed, and change in area of each individual cloud are recorded. In the case of two clouds being matched, the direction, speed, and change in area are calculated to the weighted centroid of the detected regions. There are two other situations which need to be mentioned. If a cloud appears in the previous image and is not located in the current image, it is assumed to have dissipated or left the image radius and is ignored. In the other situation where a cloud exists in the current image but does not appear in the previous image, which would happen when a cloud forms or first appears in the image, the new cloud is assigned the characteristics of the general cloud motion.

The last step in the process is to create future sky images from which predictions can be made. Each cloud will be individually cropped out of the image and placed in a new location based on the direction and distance traveled and resized according to the change in area. FIG. 37 shows one original cloud region 3702 with its binary region representation 3704. The original cloud region 3702 is shown as the region 3706 after resizing according to the change in area value, and its binary representation is referenced 3708. In this case, the cloud area was decreased by approximately 10% indicating that the cloud is shrinking.

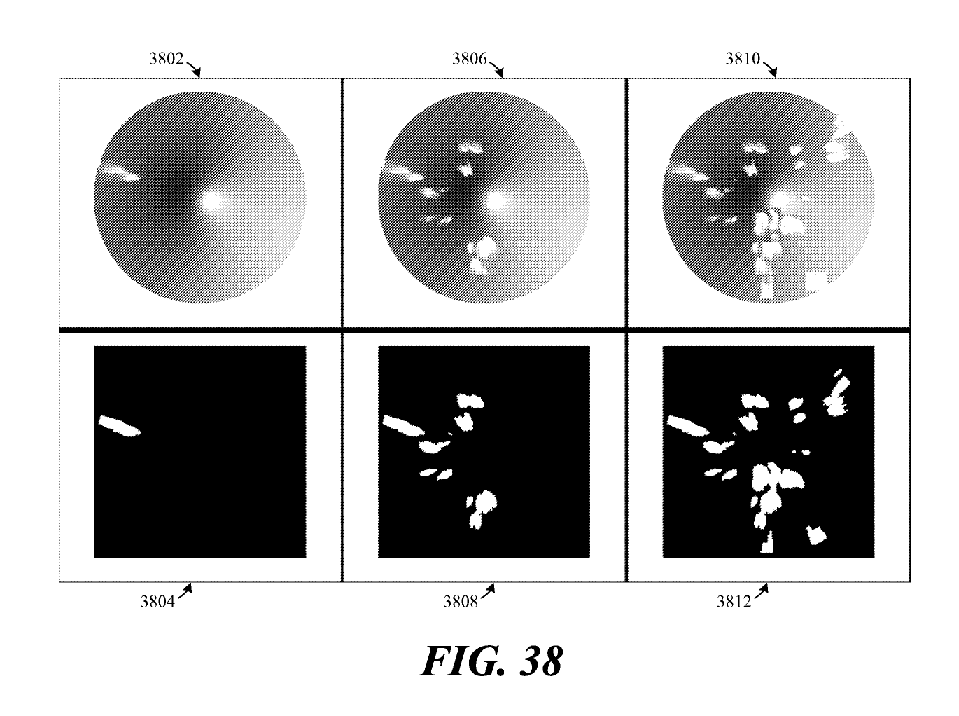

FIG. 38 presents the complete process of creating a future image. At 3802, one cloud has been cropped from an original sky image, resized, and then pasted on to a clear sky image at a corresponding location, and its binary image is at 3804. In this case, clouds are being moved to represent one time step ahead, which is 30 seconds in the future, although other time steps may be used. At 3806, ten clouds have been pasted onto the clear sky image, and the corresponding binary image is at 3808. At 3810, all clouds have been pasted, and the corresponding binary image is at 3812. The result is an image that represents the position of all clouds 30 seconds ahead of the current time.

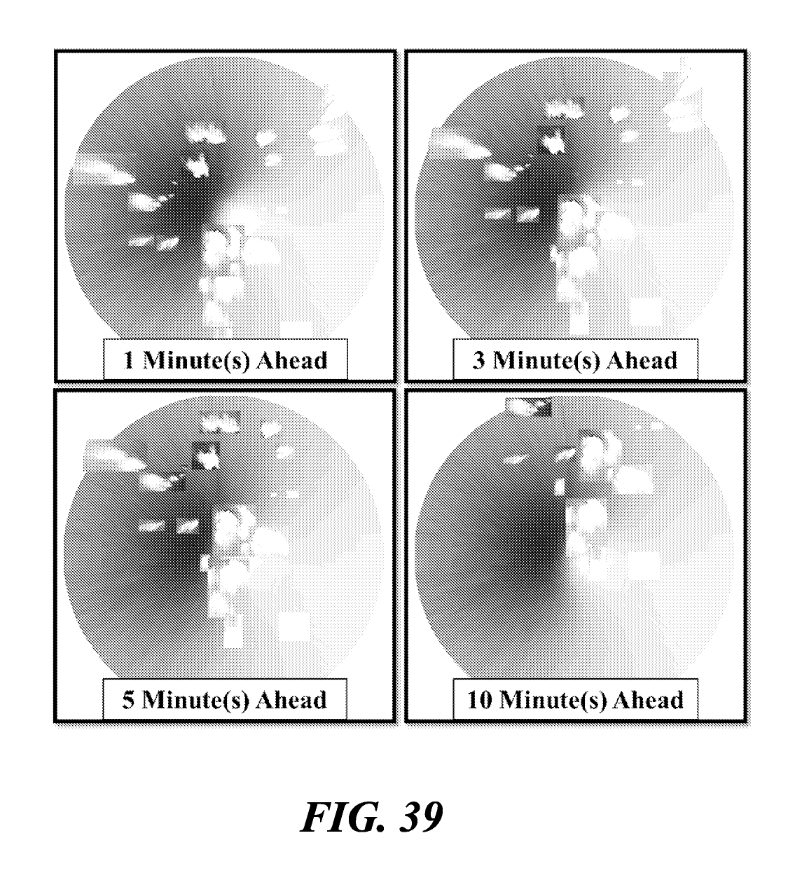

FIG. 39 shows final sky image results of creating future images. In this example, a selection of the future images are shown at intervals of 1 minute, 3 minutes, 5 minutes, and 10 minutes ahead. Among the images, clouds can be seen moving in the general direction but with some variability due to their individual motion characteristics. In some embodiments, more than one degree of freedom could be tracked in cloud motion.

Referring back to FIG. 2, at reference numeral 214, the process 200 includes generating a solar energy forecast by ray tracing irradiance of the sun upon a geographic location based on motion of one or more clouds. The solar energy forecast may be generated by the solar energy forecaster 138. The preceding steps have processed sky images to the point where predictions of irradiance on the ground can be determined by the solar energy forecast engine 130. In the step of ray tracing at reference numeral 214, original and future sky images are relied upon. In some cases, both RGB and binary segmented original and future sky images may be relied upon. In addition, the image of one or more ground locations, with either a point of interest designated (e.g., location of irradiance sensor) or a region of points selected (e.g., solar array) may be used as an input.

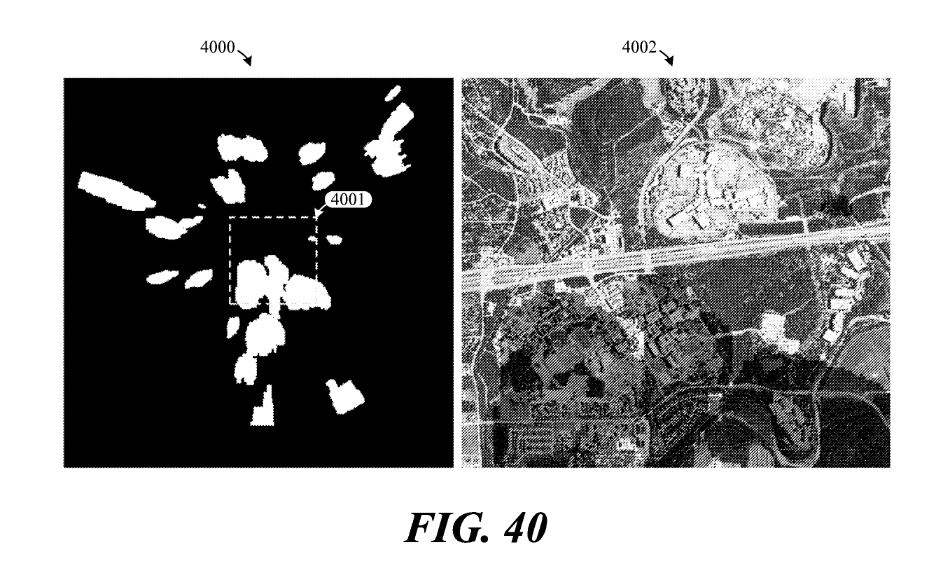

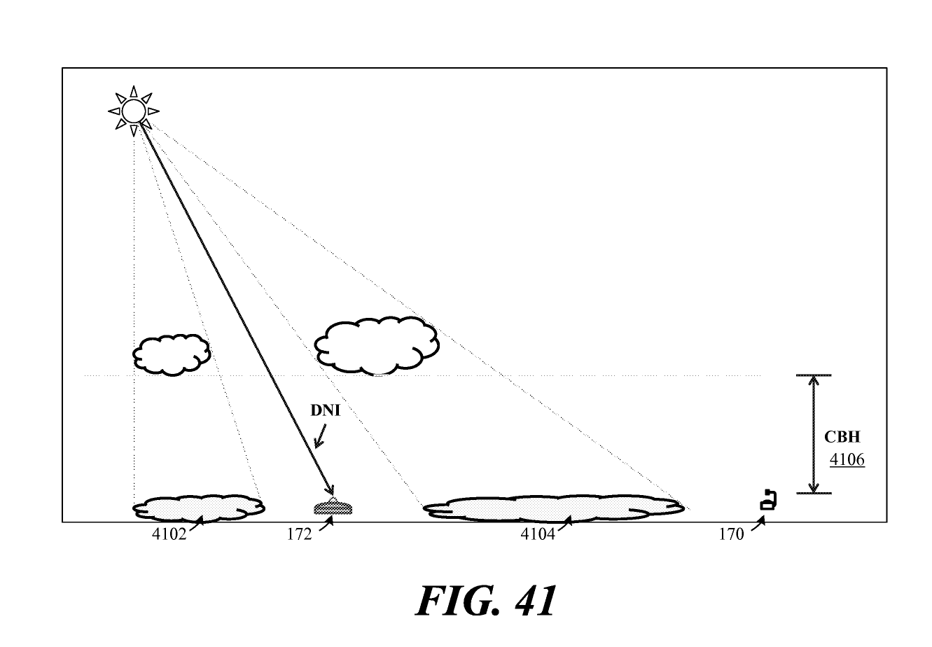

In FIG. 40, a binary segmented cloud image 4000 is shown on the left and an aerial view 4002 is shown on the right. The region 4001 is representative of the ground coverage of the aerial view 4002. FIG. 41 illustrates a view of the geometry involved in calculating the projection of cloud shadows 4102 and 4104 onto the ground and calculating irradiance estimations at a given point on the ground. The process of projecting a ray of light from the sun to a point on the ground is described herein as ray tracing. In FIG. 41, the clouds in the sky can be representative of original or future sky images processed by the solar energy forecast engine 130. The height of the clouds in original or future sky images may be considered at the CBH 4106 above the ground.

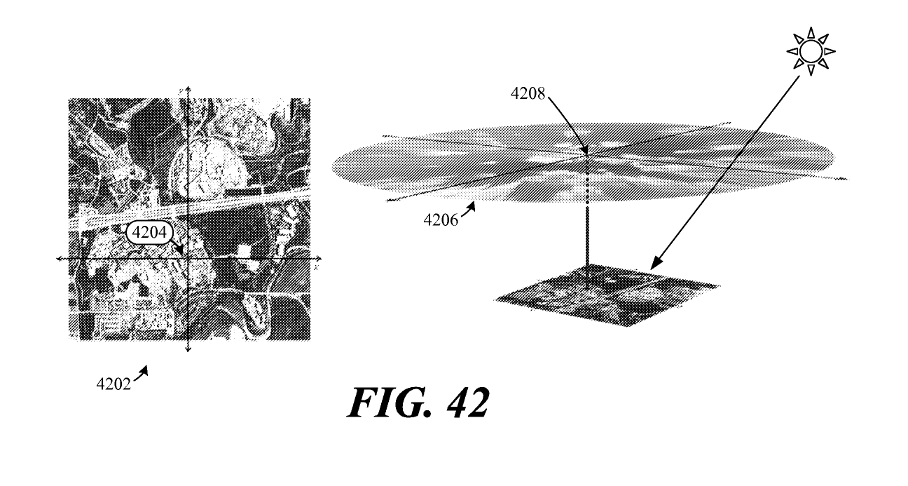

In the image 4202 in FIG. 42, the ground location center pixel 4204 is representative of an example location of the sky imager 170. Thus, the coordinates for ray tracing may be located with reference to this point during ray tracing procedures. The image 4206 shows the cloud image projected above the sky imager location, with the center of the cloud image 4208 centered directly above the sky imager location. To produce an irradiance measurement or a cloud shadow projection, the ray tracing procedure can be performed from the ground pixel location through the cloud image layer to the sun, as shown in FIG. 42.

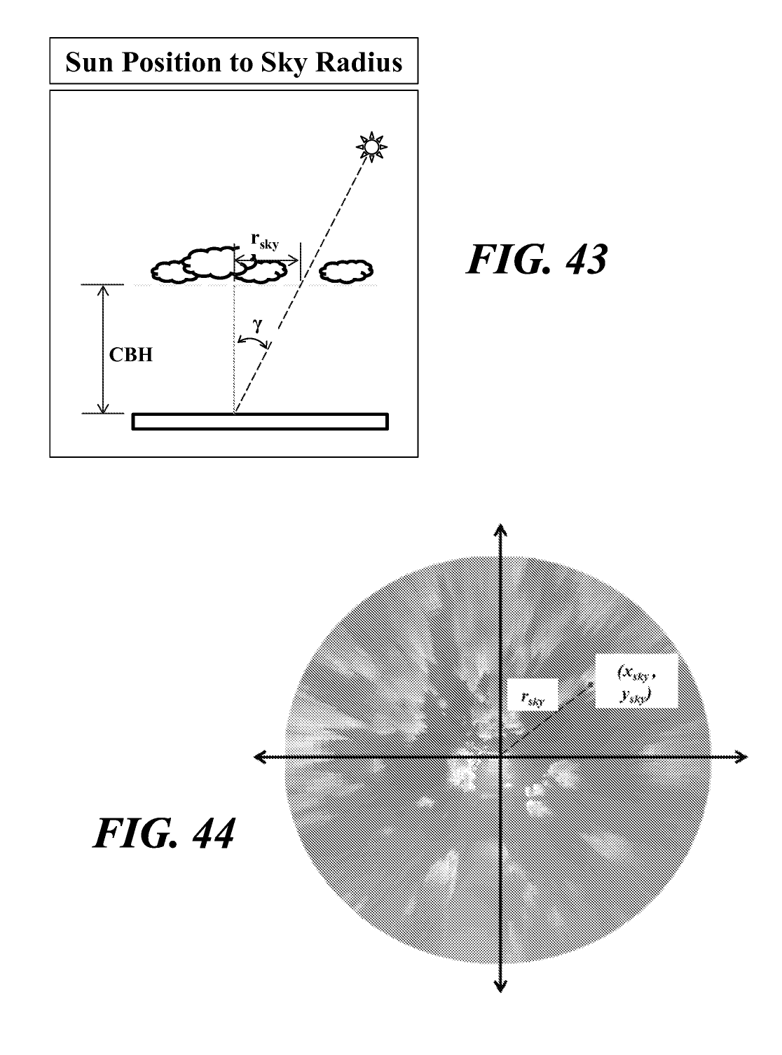

The ray tracer 136 is configured to identify each pixel in a ground location image according to the process described below. Referring between FIGS. 43 and 44, each ground pixel can be referenced to the location of the sky imager 170 and multiplied by the physical size of the location on the ground. The r_{sky} value will be calculated with the following formula:

r_{sky}=CBH*tan γ, (1.20)

where r_{sky} is the radius value in the cloud image layer, CBH is the cloud base height, and γ is the current time zenith angle obtained from SOLPOS.

In the next step, the x_{sky} and y_{sky} (FIG. 44) values are calculated from r_{sky} by the following equations:

x_{sky}=r_{sky}*sin θ and (1.21)

y_{sky}=r_{sky}*cos θ, (1.22)

where θ is the azimuth angle. The x_{sky} and y_{sky} coordinates are then referenced back to the center of the cloud image and divided by PXf, the physical size of the pixels in the cloud image.

The result of the following procedure gives an X,Y coordinate in the cloud image for each ground pixel x,y location, through the procedure of reverse ray tracing. Projecting the cloud shadows onto the ground is a matter of following this procedure and using the binary segmented cloud image as the cloud base layer.

The DNI is a radiation beam that shines directly on a ground location. The ray tracing procedure provides a pixel intensity value from the sky image for any point on the ground. In one embodiment, only one ground point with the irradiance sensor was evaluated. The resulting pixel intensity value can be obtained from the transformed image which has the true RGB values, from the binary image which has ones and zeros for cloudy and clear, respectively, or from the subtracted red to blue ratio image, which has the cloud density values.

Below, two different methods of estimating direct irradiance are explained. The first method yields a binary DNI on/off signal from the binary image which is used for ramp prediction, while the second method gives a DNI value range from the subtracted red to blue ratio image, which can result in DNI estimates of higher accuracy. Both methods are multiplied by a clear sky DNI reference curve to provide the actual DNI estimate.

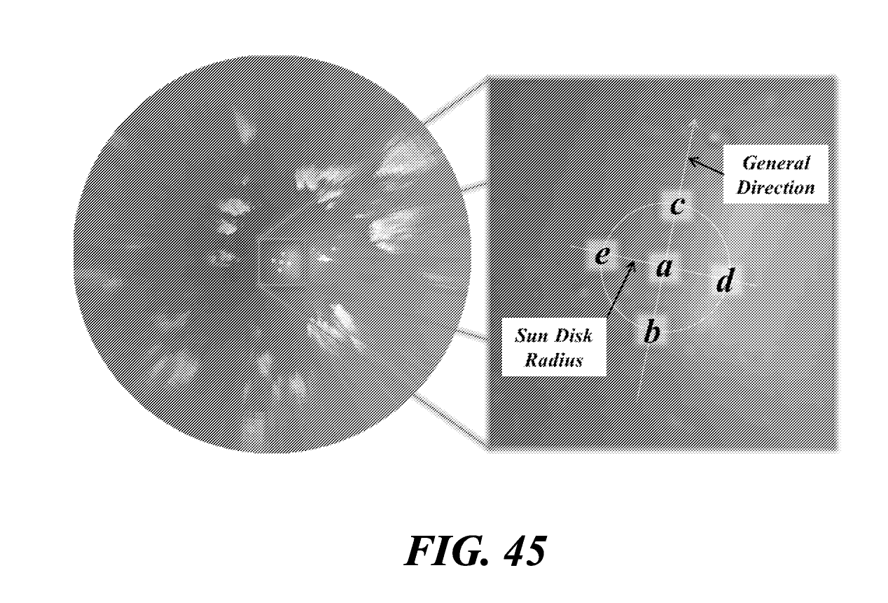

When tracing a ray from the sun through the sky image to a point on the ground, the pixel location in the sky image is often situated in the interpolated shadow band region. Due to the obstruction masking procedure, this section of the sky represents an approximation of actual sky under the shadow band. To compensate for this effect, a cross-hair approach is used to determine the value for the DNI estimation instead of using a single point, as seen in FIG. 45.

First, a user sets a sun disk radius value, which determines the spread of the points in the cross-hair. This radius is preferably set to a value which allows the cross-hair points to be outside the radius of the sun disk. Next, the cross-hair is oriented with the general direction of the cloud movement determined in the cloud motion procedure. The following weights can be assigned to each of the points when making calculations for DNI: a=3; b=2; c=2; d=1; and e=1, although other weights can be used. The rationale for weighting the cross-hair points in this way is based on the assumption that errors in cloud region translation are more likely to occur linearly with the general direction rather than perpendicular to the general direction, increasing the likelihood of an accurate DNI estimation, even when translation errors occur. The following sum of squares equation is then used to determine the final value:

signal=\sqrt{3a²+2b²+2c²+d²+e²}, (1.23)

where the output “signal” is the DNI on/off value or the DNI value range. The first method of DNI estimation creates an on/off signal by assigning the cross-hair value from the binary image. The maximum value of the output “signal” using this method is equal to three, and a threshold of 2.18 was chosen to represent the “on” level, although other threshold values may be used. This threshold ensures that the center “a” pixel plus at least one other pixel must be cloudy in order to set the DNI signal to “on”.

The second method of DNI estimation creates a normalized ranged value, between zero and one, from the subtracted red to blue ratio image. In FIG. 42, the threshold levels were set at 50, 90, and 130 to distinguish between thin and opaque clouds. Using the lower and upper thresholds as the range of the output “signal,” values of 150 and 390 can be calculated from Equation 1.23, respectively. The DNI value is then normalized on the range of 150 to 390, and values less than 150 are assigned as no cloud and greater than 390 as full cloud.

The final step in calculating the DNI estimation is to multiply the output “signal” value from either method above with a DNI reference curve. The following formulas provide a simple method for calculating a DNI reference value:

$$\begin{matrix}am = \frac{1}{cos ( zenith )} and & ( 1.24 ) \\ DNIref = cos ( zenith ) * 1368 * 0.65 \hat{} ( {am}^{0.678} ) , & ( 1.25 )\end{matrix}$$

where am is the air mass, DNIref is the path length of a ray of light through the atmosphere, and 1368 is the solar constant.

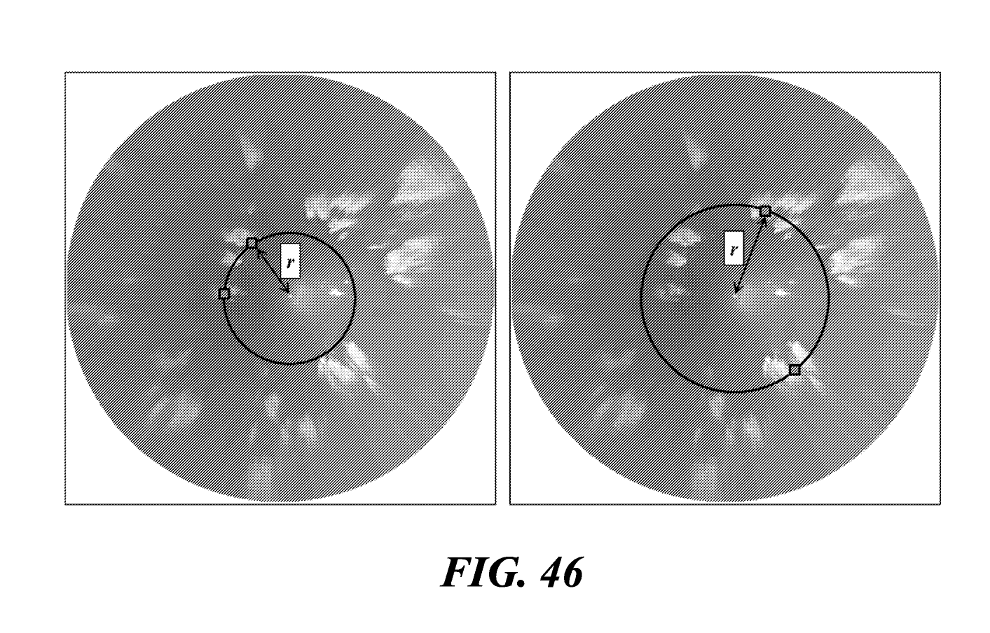

The DHI is all the radiation that reaches a point on the ground minus the direct radiation. One method of estimating DHI is to calculate the intensity of the clouds in the image in relation to their distance to the reference point. The procedure begins by scanning the entire binary image and detecting all the cloud pixels. For each detected cloud pixel, the subtracted red to blue ratio image value is acquired and divided by its distance from the reference point squared, “r²”. FIG. 46 shows an example of how squaring the distance gives more weight to pixels closer to the reference pixel. The values are then summed and normalized on a scale from zero to 250, resulting in the estimated DHI for the current image. The final step in the ray tracing/irradiance estimation procedure is to sum the estimated DNI and DHI to produce a GHI value, as described in further detail below. As compared to the embodiments described herein, conventional methods have previously estimated DNI or GHI as an “on/off” signal multiplied by a reference curve.

Above, the results of global horizontal irradiance estimations for one pass through the solar energy forecasting engine 130 are described. Using a single pass assumes that the instrumentation used or the steps in the process do not introduce any errors into the results. Referring back to FIG. 2, at reference numeral 216, the process 200 includes performing an uncertainty analysis. Particularly, a Monte Carlo simulation can be performed to make the user aware of the certainty of the predictions.

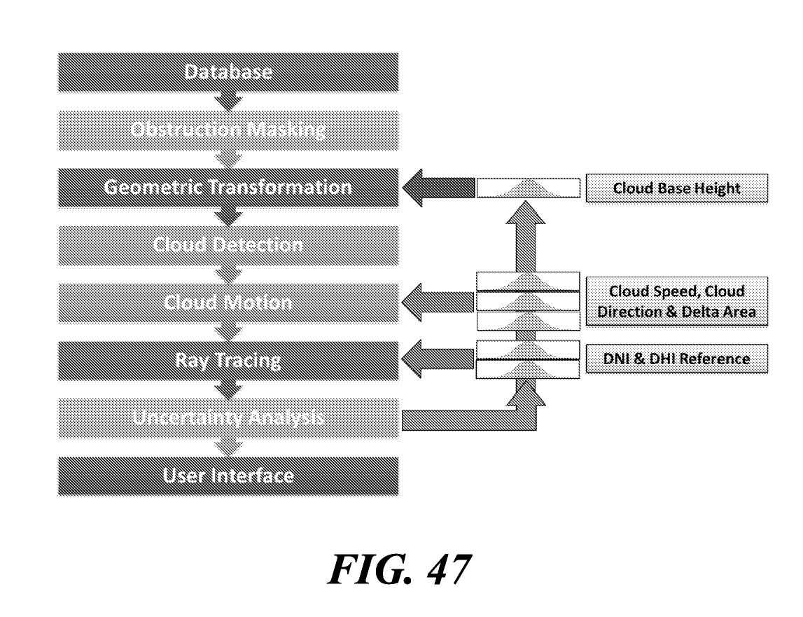

FIG. 47 shows a diagram of how a Monte Carlo simulation may be included into the procedure. After the first pass through the solar forecasting engine, five possible variables with uncertainty can be analyzed. The variables include cloud base height, individual cloud speed, individual cloud direction, individual cloud delta area (change in area), and DNI/DHI reference. The Monte Carlo procedure can be performed obtaining measured values of cloud base height, speed, direction, delta area, and DNI/DHI references. One or more of the values are multiplied by a coefficient of variation (e.g., the estimated error associated with the instrument or process). The result is multiplied by a random number in the range −1 to 1 and added to the measured value. The solar energy forecast engine 130 is run to acquire a new irradiance estimation. This process may be repeated any number of times, and certain standard deviations away from a median identified as one or more confidence bands.

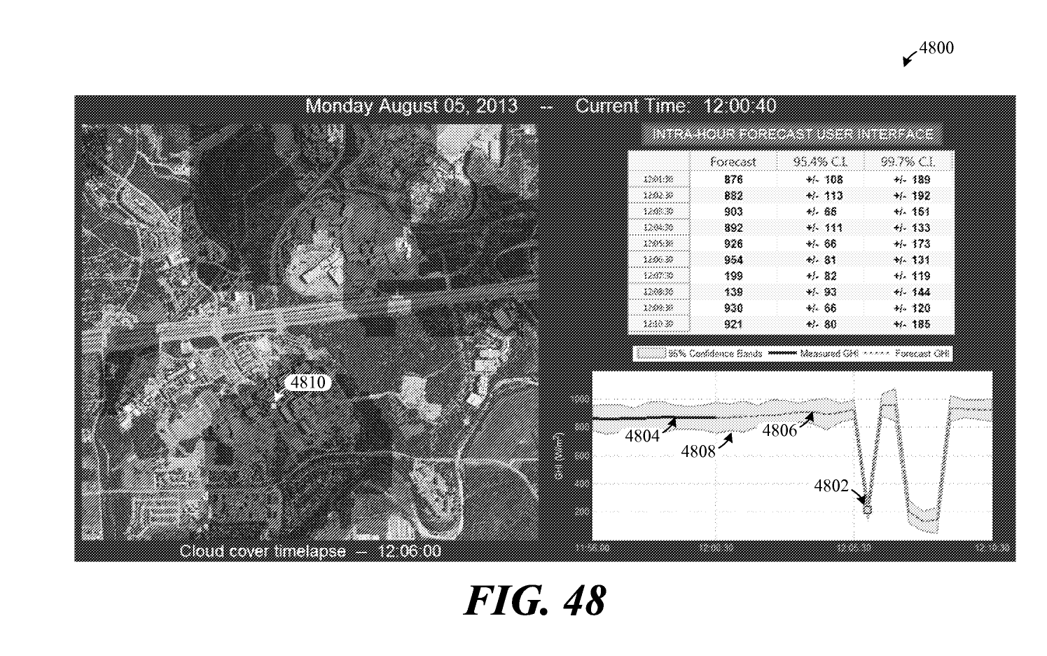

The final goal of the forecasting process 200 (FIG. 2) is to display the results to the end user at reference numeral 218. A screen shot of an example user interface 4800, which may be generated by the forecast interface display engine 140 (FIG. 1), is shown in FIG. 48. The purpose of the interface is to display the results of the forecasting process in a simple way. On the left side of the interface is a time lapse of the ground cloud cover, beginning five minutes before the current time and ending 10 minutes into the future, for example. The images in the time lapse are at 30 second intervals, so there are a total of 30 images in each cycle of the time lapse. Also shown on the ground image is marker 4810 indicating the location of the GHI sensor, and a marker 4802 indicating the current time displayed in the time lapse.

In the bottom right of the interface is the graphical display of the measured GHI 4804 and forecast GHI 4806, surrounded by a 95.4% confidence band 4808. The top right shows in tabular form the minute by minute forecasts of GHI for the next ten minutes along with the +/− values for the confidence intervals at 95.4% and 99.7%. The user interface 4800 can run through a time lapse twice every thirty seconds and the information will refresh when a new image becomes available. All information on the interface can be updated only during refreshes.

From day-ahead forecasts, utilities can learn expected ramp rates of their solar generation for each coming day, but atmospheric conditions are not always completely predictable. Therefore, timing related to day-ahead predictions could be several hours off. This scenario is where intra-hour prediction becomes more important to utilities, as it allows them to make the necessary adjustments in generation availability to match with the new expected power ramps. According to aspects of the embodiments, intra-hour forecasting can be improved using the rule-generation and pattern-recognition capabilities provided by the forecast data store 120 and the solar energy forecast engine 130. For example, cloud detection algorithms can be improved through an adaptive rule generation approach.

In digital image processing, one relatively difficult task has been object detection, especially for objects that are complex and dynamic, such as clouds. Object detection can be simplified if sample objects can be used as a starting point in the detection algorithm. Through the use of the interface, such “sample objects” can be identified by users and applied as one or more references in the detection algorithm. As a result of improved detection of the clouds within an image, the high-fidelity forecasts which rely on these images can be made more reliable.

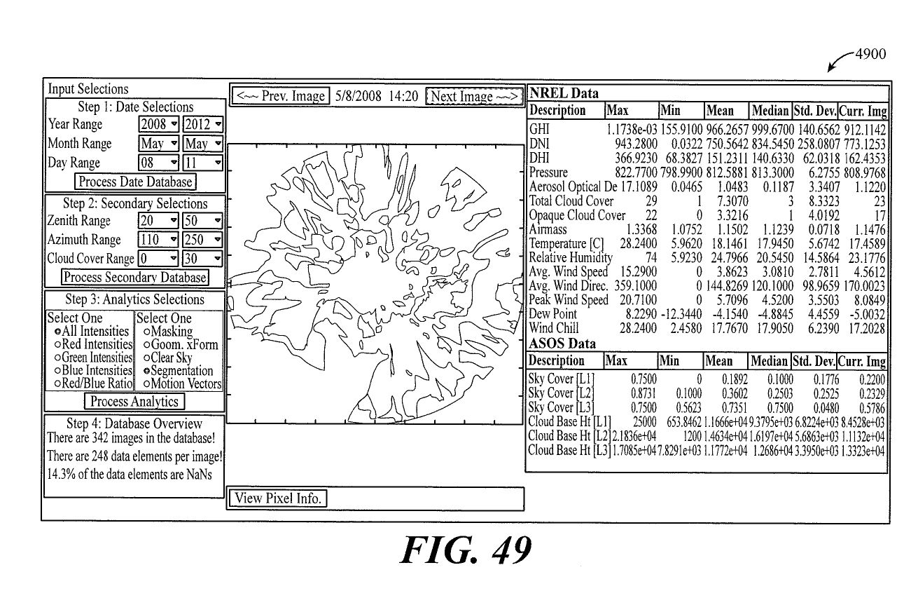

A screen shot of another example user interface 4900, which may be generated by the forecast interface display engine 140 (FIG. 1), is shown in FIG. 49. As shown in FIG. 49, the forecast interface display engine 140 may generate an interface that presents forecast and other data stored in the historical data 124 in an organized and accessible format. In the top left section of the user interface 4900, labeled step 1, a user may select a date range to analyze and processes data to reveal other range variables in step 2. In step 2, available zenith, azimuth, and cloud cover percent ranges are presented based on the sub-database selected in step 1. After making selections in step 2 and further processing to reduce the sub-database, the user may be presented with various analytics choices in step 3. An overview of sub-database characteristics is presented in step 4. From the information presented in step 4, the user can determine the relevance of the current search conditions by looking at the number of images, other data metrics, or unavailable (e.g., not applicable (N/A), non a number, etc.) entries in the new sub-database. The interface also allows the user to export selected sub-datasets and raw or processed images for further analysis or to other forecasting modules as desired. For example, data may be exported to another geographic information system (GIS) for use by operators in their distributed and large-scale solar energy systems.

The use of the user interface 4900 can aid in the development of adaptive image processing algorithms. For example, if computer software has difficulty in synthetizing results that otherwise would be easier for a human to detect, the interface makes it possible for a user to identify features on the images by flagging or painting areas on the image. This allows the cloud segmentation algorithm to learn from its user by storing the flagged or painted associations. Recognizing that a particular type of cloud cover exists during a given time of year and using that knowledge or understanding to enhance the cloud detection algorithm may significantly improve the data analytics provided by the embodiments described herein.

Statistical information can also be acquired from the interface about the meteorological data related to a given sky image. This information can be used as the basis for training and developing rules for an adaptive artificial neural network (AANN). One example AANN is one that uses a training data set to build a predictive network. From this network, simulations of future data can be performed. It is noted that some neural networks are relatively sensitive to the set of training data. Generally, accurate and relevant training data assists to make accurate simulations and reliable forecasts. The coupling of imagery and meteorological data is an example of a relevant training data input. In this way, a user may apply knowledge of the science behind cloud formation to the database and search for patterns and correlations in atmospheric data. These correlated data points can then be used as the inputs to an AANN, resulting in a more finely tuned high-fidelity solar forecasting algorithm. In addition, as image processing algorithms continually refine the properties associated with the clouds in an image, such as type, roughness, and depth of the clouds, the set of AANN training data can be adjusted to more closely match the expected cloud conditions.

FIG. 50 illustrates an example schematic block diagram of the computing environment 110 employed in the networked environment 100 of FIG. 1 according to various embodiments of the present disclosure. The computing environment 110 includes one or more computing devices 5000. Each computing device 5000 includes at least one processing system, for example, having a processor 5002 and a memory 5004, both of which are electrically and communicatively coupled to a local interface 5006. To this end, each computing device 5000 may be embodied as, for example, at least one server computer or similar device. The local interface 5006 may be embodied as, for example, a data bus with an accompanying address/control bus or other bus structure as can be appreciated.

In various embodiments, the memory 5004 stores data and software or executable-code components executable by the processor 5002. For example, the memory 5004 may store executable-code components associated with the solar energy forecast engine 130, for execution by the processor 5002. The memory 5004 may also store data such as that stored in the meteorological data store 120, among other data.

It should be understood and appreciated that the memory 5004 may store other executable-code components for execution by the processor 5002. For example, an operating system may be stored in the memory 5004 for execution by the processor 5002. Where any component discussed herein is implemented in the form of software, any one of a number of programming languages may be employed such as, for example, C, C++, C#, Objective C, JAVA®, JAVASCRIPT®, Perl, PHP, VISUAL BASIC®, PYTHON®, RUBY, FLASH®, or other programming languages.

As discussed above, in various embodiments, the memory 5004 stores software for execution by the processor 5002. In this respect, the terms “executable” or “for execution” refer to software forms that can ultimately be run or executed by the processor 5002, whether in source, object, machine, or other form. Examples of executable programs include, for example, a compiled program that can be translated into a machine code format and loaded into a random access portion of the memory 5004 and executed by the processor 5002, source code that can be expressed in an object code format and loaded into a random access portion of the memory 5004 and executed by the processor 5002, or source code that can be interpreted by another executable program to generate instructions in a random access portion of the memory 5004 and executed by the processor 5002, etc. An executable program may be stored in any portion or component of the memory 5004 including, for example, a random access memory (RAM), read-only memory (ROM), magnetic or other hard disk drive, solid-state, semiconductor, or similar drive, universal serial bus (USB) flash drive, memory card, optical disc (e.g., compact disc (CD) or digital versatile disc (DVD)), floppy disk, magnetic tape, or other memory component.

In various embodiments, the memory 5004 may include both volatile and nonvolatile memory and data storage components. Volatile components are those that do not retain data values upon loss of power. Nonvolatile components are those that retain data upon a loss of power. Thus, the memory 5004 may include, for example, a RAM, ROM, magnetic or other hard disk drive, solid-state, semiconductor, or similar drive, USB flash drive, memory card accessed via a memory card reader, floppy disk accessed via an associated floppy disk drive, optical disc accessed via an optical disc drive, magnetic tape accessed via an appropriate tape drive, and/or other memory component, or any combination thereof. In addition, the RAM may include, for example, a static random access memory (SRAM), dynamic random access memory (DRAM), or magnetic random access memory (MRAM), and/or other similar memory device. The ROM may include, for example, a programmable read-only memory (PROM), erasable programmable read-only memory (EPROM), electrically erasable programmable read-only memory (EEPROM), or other similar memory device.

Also, the processor 5002 may represent multiple processors 5002 and/or multiple processor cores and the memory 5004 may represent multiple memories that operate in parallel, respectively, or in combination. Thus, the local interface 5006 may be an appropriate network or bus that facilitates communication between any two of the multiple processors 5002, between any processor 5002 and any of the memories 5004, or between any two of the memories 5004, etc. The local interface 5006 may include additional systems designed to coordinate this communication, including, for example, a load balancer that performs load balancing. The processor 5002 may be of electrical or of some other available construction.

As discussed above, the solar energy forecast engine 130 may be embodied, in part, by software or executable-code components for execution by general purpose hardware. Alternatively the same may be embodied in dedicated hardware or a combination of software, general, specific, and/or dedicated purpose hardware. If embodied in such hardware, each can be implemented as a circuit or state machine, for example, that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart or process diagram of FIG. 2 is representative of certain processes, functionality, and operations of embodiments discussed herein. Each block may represent one or a combination of steps or executions in a process. Alternatively or additionally, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as the processor 5002. The machine code may be converted from the source code, etc. Further, each block may represent, or be connected with, a circuit or a number of interconnected circuits to implement a certain logical function or process step.

Although the flowchart or process diagram of FIG. 2 illustrates a specific order, it is understood that the order may differ from that which is depicted. For example, an order of execution of two or more blocks may be scrambled relative to the order shown. Also, two or more blocks shown in succession in FIG. 2 may be executed concurrently or with partial concurrence. Further, in some embodiments, one or more of the blocks shown in FIG. 2 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the solar energy forecast engine 130, that are embodied, at least in part, by software or executable-code components, may be embodied or stored in any tangible or non-transitory computer-readable medium or device for execution by an instruction execution system such as a general purpose processor. In this sense, the logic may be embodied as, for example, software or executable-code components that can be fetched from the computer-readable medium and executed by the instruction execution system. Thus, the instruction execution system may be directed by execution of the instructions to perform certain processes such as those illustrated in FIG. 2. In the context of the present disclosure, a “computer-readable medium” can be any tangible medium that can contain, store, or maintain any logic, application, software, or executable-code component described herein for use by or in connection with an instruction execution system.

The computer-readable medium can include any physical media such as, for example, magnetic, optical, or semiconductor media. More specific examples of suitable computer-readable media include, but are not limited to, magnetic tapes, magnetic floppy diskettes, magnetic hard drives, memory cards, solid-state drives, USB flash drives, or optical discs. Also, the computer-readable medium may include a RAM including, for example, an SRAM, DRAM, or MRAM. In addition, the computer-readable medium may include a ROM, a PROM, an EPROM, an EEPROM, or other similar memory device.

Further, any logic or application(s) described herein, including the adaptive topic logic, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device, or in multiple computing devices in the same computing environment 110. Additionally, it is understood that terms such as “application,” “service,” “system,” “engine,” “module,” and so on may be interchangeable and are not intended to be limiting.

Disjunctive language, such as the phrase “at least one of X, Y, or Z,” unless specifically stated otherwise, is to be understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A method of solar energy forecasting, comprising:
masking, by at least one computing device, at least one sky image to provide at least one masked sky image, the at least one sky image including an image of at least one cloud;
geometrically transforming, by the at least one computing device, the at least one masked sky image to at least one flat sky image based on a cloud base height of the at least one cloud;
identifying, by the at least one computing device, the image of the at least one cloud in the at least one flat sky image;
determining, by the at least one computing device, motion of the at least one cloud over time; and
generating, by the at least one computing device, a solar energy forecast by ray tracing irradiance of the sun upon a geographic location based on the motion of the at least one cloud.

2. The method according to claim 1, wherein the masking comprises masking at least one of a camera arm or a shadow band from the at least one sky image to provide the at least one masked sky image.

3. The method according to claim 2, wherein the masking comprises interpolating data for at least one of the camera arm or the shadow band using an average of linear interpolation and weighted interpolation.

4. The method according to claim 1, wherein identifying the image of the at least one cloud comprises identifying the at least one cloud based on a ratio of red to blue in pixels of the flat sky image.

5. The method according to claim 1, wherein identifying the image of the at least one cloud comprises identifying at least two layers of cloud density based on respective cloud density thresholds.

6. The method according to claim 1, wherein the geometric transforming comprises transforming the at least one masked sky image to the at least one flat sky image according to a conversion of dome coordinates to sky coordinates.

7. The method according to claim 1, further comprising generating at least one future sky image, wherein the solar energy forecast is generated using the future sky image.

8. The method according to claim 1, further comprising:
calibrating a sky imager based on at least one geometric reference; and
capturing the at least one sky image using the sky imager.

8. The method according to claim 1, wherein the solar energy forecast comprises an intra-hour solar energy forecast.

9. A solar energy forecasting computing environment, comprising:
an image operator configured to:
mask at least one sky image to provide at least one masked sky image, the at least one sky image including an image of at least one cloud; and
geometrically transform the at least one masked sky image to at least one flat sky image based on a cloud base height of the at least one cloud;
a cloud detector configured to:
identify the image of the at least one cloud in the at least one flat sky image; and
determine motion of the at least one cloud over time; and
a solar energy forecaster configured to generate a solar energy forecast by ray tracing irradiance of the sun upon a geographic location based on the motion of the at least one cloud.

10. The computing environment according to claim 9, wherein the image operator is further configured to mask at least one of a camera arm or a shadow band from the at least one sky image to provide the at least one masked sky image.

11. The computing environment according to claim 10, wherein the image operator is further configured to interpolate data for at least one of the camera arm or the shadow band using an average of linear interpolation and weighted interpolation.

12. The computing environment according to claim 9, wherein the cloud detector is further configured to identify the at least one cloud based on a ratio of red to blue in pixels of the flat sky image.

13. The computing environment according to claim 9, wherein the cloud detector is further configured to identify at least two layers of cloud density based on respective cloud density thresholds.

14. The computing environment according to claim 9, wherein the solar energy forecaster is further configured to generate at least one future sky image, and the solar energy forecast is generated using the future sky image.

15. The computing environment according to claim 9, wherein the solar energy forecast comprises an intra-hour solar energy forecast.

16. A method of solar energy forecasting, comprising:
geometrically transforming, by at least one computing device, at least one sky image to at least one flat sky image based on a cloud base height associated with an image of at least one cloud in the sky image;
identifying, by the at least one computing device, the image of the at least one cloud in the at least one flat sky image;
determining, by the at least one computing device, motion associated with the at least one cloud, and
generating, by the at least one computing device, a solar energy forecast by ray tracing irradiance of the sun based on the motion of the at least one cloud.

17. The method according to claim 16, further comprising masking at least one of a camera arm or a shadow band from the at least one sky image.

18. The method according to claim 16, wherein identifying the image of the at least one cloud comprises identifying the at least one cloud based on a ratio of red to blue in pixels of the flat sky image.

19. The method according to claim 16, wherein identifying the image of the at least one cloud comprises identifying at least two layers of cloud density based on respective cloud density thresholds.

20. The method according to claim 1, further comprising generating at least one future sky image, wherein the solar energy forecast comprises an intra-hour solar energy forecast generated using the future sky image.
